(19) United States
(12) Patent Application Publication
(10) Pub. No.: US 2023/0222607 A1
(43) Pub. Date: Jul. 13, 2023

(54) PARKING LOT MANAGEMENT SYSTEM, PARKING LOT MANAGEMENT METHOD, AND PROGRAM

(71) Applicant: TOYOTA JIDOSHA KABUSHIKI KAISHA, Toyota-shi Aichi-ken (JP)

(72) Inventor: Masaki Yamada, Toyota-shi Aichi-ken (JP)

(73) Assignee: TOYOTA JIDOSHA KABUSHIKI KAISHA, Toyota-shi Aichi-ken (JP)

(21) Appl. No.: 18/086,758

(22) Filed: Dec. 22, 2022

(30) Foreign Application Priority Data
Jan. 13, 2022 (JP) 2022-003711

(51) Int. Cl. G06Q 50/10; G08G 1/14

(52) U.S. Cl. CPC G06Q 50/10; G08G 1/14

(57) ABSTRACT

A parking lot management system capable of selecting places where vehicles should be parked while preventing a load of computation from being increased is provided. The parking lot management system manages a parking lot including a plurality of parking spaces so as to enable one vehicle to be parked. The parking lot condition acquisition unit acquires a parking lot condition, which is a condition of a parking block. The parking block utility calculation unit calculates the utility of each of the plurality of parking blocks using a parking block utility function, which is a utility function set in advance regarding a parking block, based on the parking lot condition. The parking block selection unit selects parking blocks to be allocated to the plurality of respective vehicles based on the utility of each of the plurality of parking blocks.

### CROSS REFERENCE TO RELATED APPLICATIONS

This application is based upon and claims the benefit of priority from Japanese patent application No. 2022-003711, filed on Jan. 13, 2022, the disclosure of which is incorporated herein in its entirety by reference.

### BACKGROUND

The present disclosure relates to a parking lot management system, a parking lot management method, and a program.

Japanese Unexamined Patent Application Publication No. 2000-132783 discloses a traffic flow simulator. The traffic flow simulator disclosed in Japanese Unexamined Patent Application Publication No. 2000-132783 divides an area to be analyzed to define a plurality of cells, and defines, for each of the cells that have been defined, an amount of a condition indicating the category of the cell. Further, the traffic flow simulator disclosed in Japanese Unexamined Patent Application Publication No. 2000-132783 refers to, for each of the cells, a local neighborhood system formed of other cells that are located in a predetermined area of the cell, changes the amount of the condition of the cell, and then executes a simulation of at least a traffic flow in a predetermined area that is adjacent to a road. In the traffic flow simulator disclosed in Japanese Unexamined Patent Application Publication No. 2000-132783, the amount of the condition indicating a category is able to indicate at least roads, vehicles, and parking spaces in a parking lot. The traffic flow simulator disclosed in Japanese Unexamined Patent Application Publication No. 2000-132783 refers to an attractive value, which is an index, when the vehicle selects a parking space, of a cell indicating the parking space among the other cells that form the local neighborhood system, and determines the cell to which the vehicle should move.

### SUMMARY

In the technique disclosed in Japanese Unexamined Patent Application Publication No. 2000-132783, for each of the cells, the local neighborhood system formed of other cells positioned in a predetermined area of this cell is referred to, the amount of condition of the cell is changed, and thus a simulation is performed. Further, in the technique disclosed in Japanese Unexamined Patent Application Publication No. 2000-132783, for each of the cells indicating the respective parking spaces, the cell to which the vehicle should move is determined. In this way, according to the technique disclosed in Japanese Unexamined Patent Application Publication No. 2000-132783, for each of the parking spaces, the place (parking space) to which the vehicle should move is determined. According to this technique, if the size of the parking lot and the number of vehicles used in the simulation increases, the number of cells increases, which may cause a computation load to increase. Therefore, according to the technique disclosed in Japanese Unexamined Patent Application Publication No. 2000-132783, it is possible that the speed at which the simulation is executed may be reduced.

The present disclosure provides a parking lot management system, a parking lot management method, and a program capable of selecting places where vehicles should be parked while preventing a load of computation from being increased.

A parking lot management system according to the present disclosure is a parking lot management system for managing a parking lot including a plurality of parking spaces so as to enable one vehicle to be parked, the parking lot management system including: a parking lot condition acquisition unit configured to acquire a parking lot condition, which is a condition of a parking block formed of the plurality of parking spaces that are adjacent to each other; a parking block utility calculation unit configured to calculate the utility of each of a plurality of the parking blocks using a parking block utility function, which is a utility function set in advance regarding the parking block, based on the parking lot condition; and a parking block selection unit configured to select parking blocks to be allocated to a plurality of respective vehicles based on the utility of each of the plurality of parking blocks.

Further, a parking lot management method according to the present disclosure is a parking lot management method for managing a parking lot including a plurality of parking spaces so as to enable one vehicle to be parked, the parking lot management method including: acquiring a parking lot condition, which is a condition of a parking block formed of the plurality of parking spaces that are adjacent to each other; calculating the utility of each of a plurality of the parking blocks using a parking block utility function, which is a utility function set in advance regarding the parking block, based on the parking lot condition, and selecting parking blocks to be allocated to a plurality of respective vehicles based on the utility of each of the plurality of parking blocks.

Further, a program according to the present disclosure is a program executing a parking lot management method for managing a parking lot including a plurality of parking spaces so as to enable one vehicle to be parked, the program causing a computer to execute the processing of: acquiring a parking lot condition, which is a condition of a parking block formed of the plurality of the parking spaces that are adjacent to each other; calculating the utility of each of a plurality of the parking blocks using a parking block utility function, which is a utility function set in advance regarding the parking block, based on the parking lot condition, and selecting parking blocks to be allocated to a plurality of respective vehicles based on the utility of each of the plurality of parking blocks.

According to the aforementioned configuration of the present disclosure, it is possible to reduce the number of parking places to be allocated compared to a case in which parking places are allocated to vehicles by units of parking spaces. Therefore, it becomes possible to appropriately allocate parking places to the respective vehicles while reducing a computation load.

Further, the parking block selection unit may select parking blocks to be allocated to the respective vehicles in accordance with timings when the plurality of respective vehicles enter the parking lot or before the respective vehicles enter the parking lot.

According to the configuration of the present disclosure, it becomes possible to further reduce the computation load.

Further, a parameter included in the parking block utility function may be adapted in accordance with an operation condition of the parking lot.

According to the configuration of the present disclosure, it becomes possible to select a parking block that matches the preference of an actual user.

Further, the parameter included in the parking block utility function may be adapted in accordance with at least one of a type of the parking lot, a time zone, a season, and a weather.

According to the configuration of the present disclosure, it becomes possible to select a parking block that matches the preference of the actual user.

Further, the parking block utility calculation unit may calculate the utility in accordance with the number of parking spaces in the parking block where vehicles are not parked.

According to the configuration of the present disclosure, it becomes possible to select a parking block that matches the preference of the actual user by simple processing.

Further, the parking block utility calculation unit may calculate the utility using a utility function whose value decreases as the number of parking spaces in the parking block where vehicles are not parked decreases.

According to the configuration of the present disclosure, it becomes possible to select a parking block that matches the preference of the actual user by simple processing.

Further, the parking lot management system may manage a parking lot including a plurality of parking floors, each of the parking floors including a plurality of the parking blocks, the parking lot management system may further include a parking floor utility calculation unit configured to calculate the utility of each of the plurality of parking floors using a parking floor utility function, which is a utility function set in advance regarding the parking floor, the parking lot management system may further include a parking floor selection unit configured to select parking floors to be allocated to the plurality of respective vehicles based on the utility of each of the parking floors, the parking block utility calculation unit may calculate the utility of the parking block in the selected parking floor, and the parking block selection unit may select the parking block in the selected parking floor.

According to the configuration of the present disclosure, it becomes possible to efficiently manage a multistory parking lot including a plurality of parking floors separated from each other.

Further, the parking lot management system may manage a virtual parking lot, and the parking lot management system may further include a simulation processing unit configured to perform processing so as to operate the vehicle by a simulation, the selected parking block being a moving destination.

According to the configuration of the present disclosure, it becomes possible to simulate the operation of the vehicle in the parking lot at a high speed.

Further, the parking lot management system may manage an actual parking lot, and the parking lot management system may further include a presenting processing unit configured to perform processing for presenting information where the selected parking block is set as a moving destination for the vehicle which enters the parking lot.

According to the configuration of the present disclosure, it becomes possible to present a parking block that is easily accepted by an actual user.

Further, the parking lot management system may further include a learning unit configured to learn a parameter of the utility function in accordance with the operation condition of the parking lot.

According to the configuration of the present disclosure, it becomes possible to adapt the utility function that matches the preference of the actual user corresponding to the operation condition.

According to the present disclosure, it is possible to provide a parking lot management system, a parking lot management method, and a program capable of selecting places where vehicles should be parked while preventing a load of computation from being increased.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram showing a configuration of a parking lot management system according to a first embodiment;

FIG. 2 is a diagram illustrating a parking lot managed by the parking lot management system according to the first embodiment;

FIG. 3 is a diagram illustrating a graph of a utility function regarding a time element in a parking block utility function according to the first embodiment;

FIG. 4 is a diagram for describing a utility function representing the utility in accordance with ease of parking in a parking block according to the first embodiment;

FIG. 5 is a diagram illustrating a graph of a utility function regarding ease of parking in the parking block utility function according to the first embodiment;

FIG. 6 is a graph illustrating a selection percentage according to the first embodiment;

FIG. 7 is a diagram showing a configuration of a parking lot management system according to a second embodiment;

FIG. 8 is a diagram illustrating a parking lot managed by the parking lot management system according to the second embodiment;

FIG. 9 is a diagram illustrating a graph of a utility function regarding a time element in a parking floor utility function according to the second embodiment;

FIG. 10 is a diagram illustrating a graph of a utility function regarding ease of finding an available parking space in the parking floor utility function according to the second embodiment;

FIG. 11 is a diagram showing a configuration of a simulation unit according to the second embodiment;

FIG. 12 is a flowchart showing processing by a simulation unit according to the second embodiment;

FIG. 13 is a diagram showing a configuration of a presenting unit according to the second embodiment;

FIG. 14 is a flowchart showing processing by the presenting unit according to the second embodiment;

FIG. 15 is a diagram showing a configuration of a learning unit according to the second embodiment;

FIG. 16 is a flowchart showing processing by the learning unit according to the second embodiment;

FIG. 17 is a flowchart showing processing by the learning unit according to the second embodiment;

FIG. 18 is a flowchart showing processing by the learning unit according to the second embodiment; and

FIG. 19 is a flowchart showing processing by the learning unit according to the second embodiment.

### DESCRIPTION OF EMBODIMENTS

### First Embodiment

Hereinafter, with reference to the drawings, embodiments of the present disclosure will be described. For the sake of clarification of the description, the following descriptions and the drawings are omitted and simplified as appropriate. Further, throughout the drawings, the same elements are denoted by the same reference symbols and the overlapping descriptions will be omitted as appropriate.

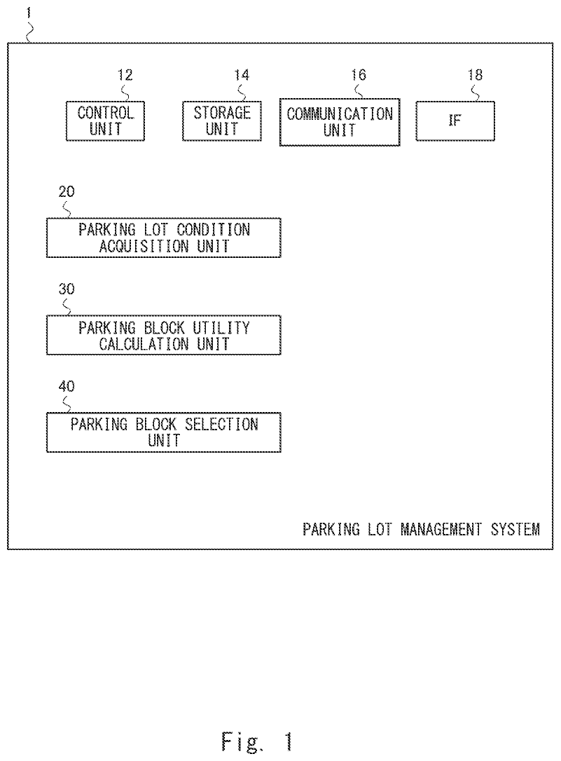

FIG. 1 is a diagram showing a configuration of a parking lot management system 1 according to a first embodiment. The parking lot management system 1 may be implemented by one or more computers. The parking lot management system 1 may be implemented by a cloud system. This is also applicable to the other embodiments.

The parking lot management system 1 manages a parking lot including a plurality of parking spaces. In this embodiment, the “parking space” is a space (section) so as to enable one vehicle to be parked. Further, the parking lot management system 1 manages a parking place (i.e., moving destination) that a vehicle entering the parking lot (a vehicle which has just entered the parking lot or a vehicle before entering the parking lot) should be parked. The parking lot management system 1 may manage a virtual parking lot (e.g., a parking lot that is being built or being designed). In this case, the parking lot management system 1 manages (selects) a parking place of a virtual vehicle in a parking lot in a virtual space implemented by a simulation or the like. Then, the parking lot management system 1 performs control in such a way that the vehicle moves to the parking place allocated to this vehicle in the virtual space. In this case, the parking lot management system 1 predicts, if a parking lot which is being designed will be operated in the future, parking places selected by the respective vehicles (drivers of the respective vehicles), and performs a simulation in such a way that the respective vehicles move to the predicted parking places in the virtual space.

Alternatively, the parking lot management system 1 may mange a parking lot that is present in reality and is in operation. In this case, the parking lot management system 1 manages (selects) a parking place for a vehicle that is present in reality. Then, the parking lot management system 1 may present (recommend) the parking place allocated to this vehicle for this vehicle (an occupant of the vehicle) and let this vehicle move to the parking place.

Note that the parking places selected (allocated) for the respective vehicles are not individual parking spaces in this embodiment. In this embodiment, the parking places selected (allocated) for the respective vehicles correspond to a parking block formed of a plurality of the parking spaces that are adjacent to each other. Therefore, the parking lot management system 1 selects the parking blocks where the respective vehicles should be parked, that is, the parking blocks to be allocated to the respective vehicles.

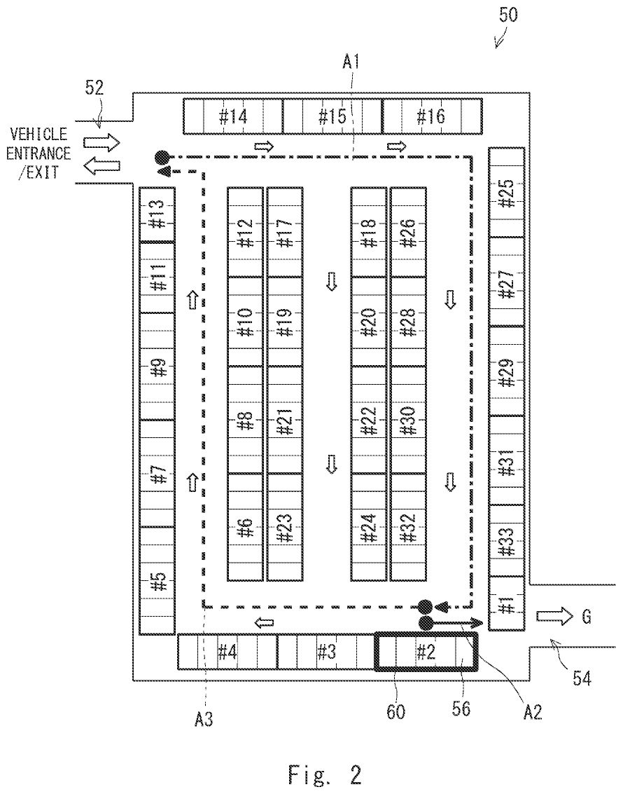

FIG. 2 is a diagram illustrating a parking lot 50 managed by the parking lot management system 1 according to the first embodiment. The parking lot 50 includes one or more vehicle entrance/exits 52, one or more walkways to a destination 54, and a large number of parking spaces 56. The walkway to the destination 54 is an entrance/exit so as to enable an occupant (pedestrian) of a vehicle to access a destination G. When the parking lot 50 is a “parking lot attached to a shopping mall”, the destination G is a “shopping mall”. Further, when the parking lot 50 is an “employee parking lot”, the destination G is an office building or the like where employees work. The parking space 56 is a space (parking area) for one vehicle to be parked. Further, while one vehicle entrance/exit 52 is shown in FIG. 2, the entrance and the exit of vehicles may be physically separated from each other.

A vehicle enters the parking lot 50 from the vehicle entrance/exit 52, travels inside the parking lot 50, and is parked in one of the parking spaces 56. An occupant of the vehicle that is parked in the parking space 56 walks inside the parking lot 50 toward the walkway to the destination 54 from the parking space 56, exits the parking lot 50 from the walkway to the destination 54, and reaches the destination G. Then, the occupant who has exited from the destination G and entered the parking lot 50 through the walkway to the destination 54 walks toward the parking space 56. Then, the vehicle which the occupant rides travels inside the parking lot 50 from the parking space 56 and exits the parking lot 50 from the vehicle entrance/exit 52.

In this embodiment, a parking block 60 formed of a plurality of parking spaces 56 that are adjacent to each other is considered. The parking lot 50 illustrated in FIG. 2 includes respective parking blocks 60 represented by parking block numbers #1 to #33.The parking blocks 60 may each include any number of parking spaces 56. For example, the parking block 60 of the parking block number #1 includes three parking spaces 56. The parking block 60 of the parking block number #2 includes five parking spaces 56. The parking block 60 of the parking block number #5 includes six parking spaces 56. The number of parking spaces 56 included in each of the parking blocks 60 may be set as appropriate in accordance with the layout or the like of the parking lot 50.

Assume, for example, that the parking lot management system 1 has selected the parking block 60 of the parking block number #2 for a vehicle entering the parking lot 50. In this case, this vehicle enters the parking lot 50 through the vehicle entrance/exit 52 and travels inside the parking lot 50 as shown by the arrow A1. Then this vehicle is parked in one of the parking spaces 56 in the parking block 60 of the parking block number #2.The occupant of the vehicle that is parked at the parking block 60 (parking space 56) walks inside the parking lot 50 toward the walkway to the destination 54 from the parking block 60 as shown by the arrow A2, exits from the parking lot 50 through the walkway to the destination 54, and goes toward the destination G. Then, the occupant who has exited from the destination G and entered the parking lot 50 through the walkway to the destination 54 walks toward the parking block 60 of the parking block number #2.Then, the vehicle that the occupant has ridden travels inside the parking lot 50 from the parking block 60 of the parking block number #2 as shown by the arrow A3, and exits from the parking lot 50 through the vehicle entrance/exit 52.

While FIG. 2 shows the parking lot 50 having only one floor, the parking lot 50 managed by the parking lot management system 1 is not limited to the parking lot 50 having only one floor. The parking lot management system 1 may manage a parking lot 50 having a plurality of parking floors (a multistory parking lot or the like).

The parking lot management system 1 (FIG. 1) includes, as main hardware components, a control unit 12, a storage unit 14, a communication unit 16, and an interface unit 18 (IF; Interface). The control unit 12, the storage unit 14, the communication unit 16, and the interface unit 18 are connected to one another via a data bus or the like.

The control unit 12 is, for example, a processor such as a Central Processing Unit (CPU). The control unit 12 has a function as an arithmetic apparatus that performs, for example, control processing and arithmetic processing. The control unit 12 may include a plurality of processors. The storage unit 14 is, for example, a storage device such as a memory or a hard disc. The storage unit 14 is, for example, a Read Only Memory (ROM) or a Random Access Memory (RAM). The storage unit 14 has a function for storing, for example, a control program(s) and an arithmetic program(s) executed by the control unit 12. That is, the storage unit 14 (memory) stores one or more instructions. Further, the storage unit 14 has a function for temporarily storing processing data and the like. The storage unit 14 may include a database. Further, the storage unit 14 may include a plurality of memories.

The communication unit 16 performs processing necessary for communicating with other apparatuses via a wired or wireless network. The communication unit 16 may include, for example, a communication port, a router, and a firewall. The interface unit 18 (IF) is, for example, a user interface (UI). The interface unit 18 includes an input device such as a keyboard, a touch panel, or a mouse, and an output device such as a display or a speaker. The interface unit 18 may be configured in such a way that the input device and the output device are integrated with each other, like a touch screen (a touch panel). The interface unit 18 receives a data input operation by a user (operator) and outputs information to the user. The interface unit 18 may display, for example, information (an allocation list that will be described later) indicating parking places selected for the respective vehicles.

Further, the parking lot management system 1 includes, as components, a parking lot condition acquisition unit 20, a parking block utility calculation unit 30, and a parking block selection unit 40. Each of the above components may be implemented, for example, by executing a program under the control of the control unit 12. More specifically, each of the components may be implemented by the control unit 12 executing a program (instruction) stored in the storage unit 14. Further, each of the components may be implemented by installing a necessary program stored in any non-volatile storage medium as required. Further, each of the components is not necessarily implemented by software executed by a program, and may instead be implemented, for example, by any combination of hardware, firmware, and software. Further, each of the components may also be implemented using a user-programmable integrated circuit, such as a field-programmable gate array (FPGA) or a microcomputer. In this case, a program composed of each of the aforementioned components may be implemented by using this integrated circuit. The same is applicable to other example embodiments that will be described later.

The parking lot condition acquisition unit 20 acquires the condition (parking lot condition) of the parking lot 50 managed by the parking lot management system 1. The parking lot condition acquisition unit 20 acquires the parking lot condition, which is the condition of the parking block 60. More specifically, the parking lot condition acquisition unit 20 acquires information (parking lot condition information) indicating how many vehicles are parked in each of the parking blocks 60 in the parking lot 50. In other words, the parking lot condition acquisition unit 20 may acquire, for each of the parking blocks 60 in the parking lot 50, information indicating how many more vehicles can be parked therein.

When the parking lot management system 1 manages a virtual parking lot 50, the parking lot condition acquisition unit 20 may acquire, in the middle of allocating the current parking place (parking block 60), information (parking lot condition information) indicating the number of vehicles to which the respective parking blocks 60 have been allocated. Further, when the parking lot management system 1 manages the parking lot 50 which is in operation, the parking lot condition acquisition unit 20 may acquire information (parking lot condition information) indicating the number of vehicles that are parked in each of the parking blocks 60 at this stage using a sensor or the like. Alternatively, when the parking lot management system 1 manages a parking lot 50 which is in operation, the parking lot condition acquisition unit 20 may acquire information (parking lot condition information) indicating the number of vehicles to which the respective parking blocks 60 have been allocated at this stage.

The parking block utility calculation unit 30 calculates the utility of each of the plurality of parking blocks 60 using the parking block utility function based on the parking lot condition. The parking block utility function is a utility function set in advance regarding the parking block 60. The parking block utility function is a function expressing the utility (degree of attractiveness) of the corresponding parking block 60 for the vehicle (occupant). That is, the utility of the parking block 60 corresponds to the value of the utility function regarding the parking block 60.

The parking block utility function may be expressed in accordance with the travelling time of the vehicle between the parking block 60 and the vehicle entrance/exit 52, the occupant's walking time between the parking block 60 and the walkway to the destination 54 (destination G), and ease of parking in the parking block 60. The reference point of the parking block 60 when the travelling time and the walking time are defined may be, for example, a point on a passage that faces the parking block 60 or may be the center point of the parking block 60. The travelling time of the vehicle may be defined in accordance with the travelling distance from the vehicle entrance/exit 52 to the reference point of the parking block 60 at the time of entrance and the travelling distance from the reference point of the parking block 60 to the vehicle entrance/exit 52 at the time of exit. Likewise, the occupant's walking time may be defined in accordance with the walking distance between the reference point of the parking block 60 and the walkway to the destination 54 (destination G). Further, ease of parking in the parking block 60 may be defined in accordance with the number of vehicles that have already been parked in one of the parking spaces 56 in the parking block 60 (the number of vehicles that are parked).

If it is assumed that j is an index indicating the parking block number, the parking block utility function V₃ regarding the parking block number #j may be expressed, for example, by the following Expression (1).

[Expression 1]

Vⱼ=V_{L}(L)·V_{P}(J) (1)

In Expression (1), V_{L}(L) denotes a utility function representing the utility in accordance with the position (distance) of the parking block 60. In other words, V_{L}(L) denotes a utility function expressed by the travelling time of the vehicle and the occupant's walking time. That is, V_{L}(L) denotes a utility function regarding the time element (position).

The utility function V_{L}(L) regarding the time element L may be expressed, for example, by the following Expression (2).

[Expression 2]

V_{L}(L)=αe^{-Lβ}α,β>0 (2)

In Expression (2), α and β denote parameters in the utility function (utility function parameters). The symbol a is a parameter for adjusting the absolute value of the utility and is a constant. The symbol β may be set by, for example, learning in a predetermined operation condition in advance. That is, β may be adapted in accordance with the operation condition of the parking lot. That is, β may vary in accordance with the operation condition of the parking lot. In other words, β may vary if the operation condition of the parking lot varies. The details thereof will be described later.

Further, the time element L may be expressed, for example, by the following Expression (3).

L=c·(travelling time of vehicle)+w·(walking time) (3)

In Expression (3), c and w are parameters in the utility function (utility function parameters). The symbol c is a parameter that corresponds to the weight of the travelling time of the vehicle. The symbol w is a parameter that corresponds to the weight of the walking time. The symbols c and w may be set by, for example, learning under a predetermined operation condition in advance. That is, c and w may be adapted in accordance with the operation condition of the parking lot. That is, c and w may vary in accordance with the operation condition of the parking lot. In other words, c and w may vary if the operation condition of the parking lot varies. The details thereof will be described later.

Further, the time element L corresponds to the travelling time of the vehicle, that is, the distance between the corresponding parking block 60 and the vehicle entrance/exit 52 and the walking time, that is, the distance between the parking block 60 and the walkway to the destination 54. The “travelling time of the vehicle” is obtained by dividing a weighted average of the travelling distance from the vehicle entrance/exit 52 to the reference point of the parking block 60 at the time of entrance and the travelling distance from the reference point of the parking block 60 to the vehicle entrance/exit 52 at the time of exit by the travelling speed of the vehicle. The weight with respect to the travelling distance (travelling time) at the time of entrance is denoted by dᵢ and the weight with respect to the travelling distance (travelling time) at the time of exit is denoted by dₒ. Here, dₒ=1−dᵢ>0. The symbols dᵢ and dₒ are parameters in the utility function (utility function parameters). The symbols dᵢ and dₒ may be set by, for example, learning in a predetermined operation condition in advance. That is, dᵢ and dₒ may be adapted in accordance with the operation condition of the parking lot. That is, dᵢ and dₒ may vary in accordance with the operation condition of the parking lot. In other words, dᵢ and dₒ may vary if the operation condition of the parking lot varies. The details thereof will be described later. Further, the “walking time” can be obtained by dividing the walking distance between the reference point of the parking block 60 and the walkway to the destination 54 (destination G) by the walking speed.

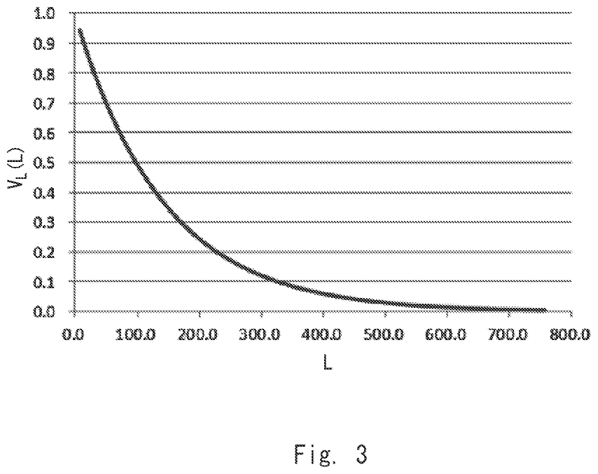

FIG. 3 is a diagram illustrating a graph of the utility function V_{L}(L) regarding the time element in the parking block utility function according to the first embodiment. In the graph shown in FIG. 3, the horizontal axis corresponds to L in Expression (2) and the vertical axis corresponds to V_{L}(L) in Expression (2). As shown in FIG. 3, the value of the utility function V_{L}(L) regarding the time element decreases as L increases. That is, the utility function V_{L}(L) regarding the time element in the parking block utility function is a monotonically decreasing function for L.

Further, in Expression (1), V_{P}(J) is a utility function representing the utility in accordance with ease of parking in the parking block 60. The symbol J in V_{P}(J) denotes the number of parking spaces 56 where vehicles are not parked in the parking blocks 60 (the number of remaining slots). Then, V_{P}(J) is a function whose value decreases as J decreases. Hereinafter, a definition example of V_{P}(J) will be described.

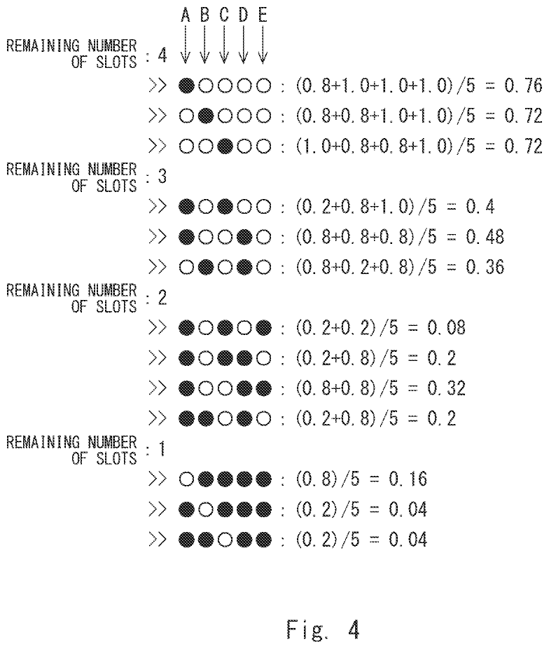

FIG. 4 is a diagram for describing the utility function V_{P}(J) that expresses the utility in accordance with ease of parking in the parking block 60 according to the first embodiment. FIG. 4 illustrates a method for defining V_{P}(J) for a parking block 60 including five parking spaces 56. In the example of FIG. 4, the parking spaces 56 are shown by circles. The parking spaces 56 where vehicles have already been parked are shown by black circles, and the parking spaces 56 where vehicles have not yet been parked are shown by white circles. Further, for the sake of convenience of the description, the parking spaces 56 are denoted by parking spaces A, B, C, D, and E in order from the parking space 56 provided on the left end.

For each of the parking spaces 56 in the parking block 60, a utility parameter p that decreases due to the presence of a vehicle (parked car) in a parking space 56 that is next to the above parking space 56 is set. If no vehicles are parked in the parking spaces 56 on either side of one parking space 56, the utility parameter regarding this parking space 56 is set to p₀=1.0. Further, if a vehicle is parked on only one of the two sides of one parking space 56, the utility parameter regarding this parking space 56 is set to p₁ (0<p₁<1.0). Further, if vehicles are parked in the parking spaces 56 on both sides of one parking space 56, the utility parameter regarding this parking space 56 is set to p₂ (0<p₂<p₁). For example, p₁=0.8 and p₂=0.2. For the sake of simplification of the calculation, it is assumed, for each of the parking spaces 56 on both ends of the parking block 60, that a parking space 56 of another parking block 60 that is adjacent to the above parking space 56 are not taken into account. Note that these utility parameters p₁ and p₂ may be set by, for example, learning in a predetermined operation condition in advance. That is, p₁ and p₂ may be adapted in accordance with the operation condition of the parking lot. That is, p₁ and p₂ may vary in accordance with the operation condition of the parking lot. In other words, p₁ and p₂ may vary if the operation condition of the parking lot varies. The details thereof will be described later. The utility parameter p of the parking space 56 where there is a vehicle is p=0.

Further, patterns of the presence or absence of parked vehicles that may occur for each of the plurality of parking spaces 56 in the parking block 60 will now be considered for each of the remaining number of slots. It is assumed here that, when there are a plurality of parking spaces 56 where there are no vehicles parked, the vehicle that will be parked next in the parking block 60 is parked in a parking space 56 having a large utility parameter that has been described above. That is, a pattern in which the next vehicle is parked in a parking space 56 that is next to a parking space 56 where there is a vehicle parked, even though there is another parking space 56, the parking spaces on both sides of which have no vehicles parked therein, is excluded.

In the example shown in FIG. 4, for a case in which the number of remaining slots is four, three patterns (there is a vehicle parked in the parking space A, there is a vehicle parked in the parking space B, and there is a vehicle parked in the parking space C) are shown. Further, for a case in which the number of remaining slots is three, three patterns (there are vehicles parked in the parking spaces A and C, there are vehicles parked in the parking spaces A and D, and there are vehicles parked in the parking spaces B and D) are shown. Further, for a case in which the number of remaining slots is two, four patterns (there are vehicles parked in the parking spaces A, C, and E, there are vehicles parked in the parking spaces A, C, and D, there are vehicles parked in the parking spaces A, D, and E, and there are vehicles parked in the parking spaces A, B, and D) are shown. Further, for a case in which the number of remaining slots is one, three patterns (there are vehicles parked in the parking spaces B, C, D, and E, there are vehicles parked in the parking spaces A, C, D, and E, and there are vehicles parked in the parking spaces A, B, D, and E) are shown. Note that patterns that are symmetrical to each other are not shown.

Further, as shown in FIG. 4, for each of the patterns in each of the remaining number of slots, the average value of the utility parameters of the respective parking spaces 56 is calculated as the utility of this pattern. Consider, for example, a case in which the number of remaining slots is four. In the pattern in which there is a vehicle parked in the parking space A, the utility parameter of the parking space A is 0, the utility parameter of the parking space B is 0.8, and the utility parameter of each of the other parking spaces C, D, and E is 1.0. Therefore, the average value of the utility parameters of this pattern is calculated as (0.8+1.0+1.0+1.0)/5=0.76.

In the pattern in which there is a vehicle parked in the parking space B, the utility parameter of the parking space B is 0, the utility parameter of each of the parking spaces A and C is 0.8, and the utility parameter of each of the parking spaces D and E is 1.0. Therefore, the average value of the utility parameters of this pattern is calculated as (0.8+0.8+1.0+1.0)/5=0.72.

In the pattern in which there is a vehicle parked in the parking space C, the utility parameter of the parking space C is 0, the utility parameter of each of the parking spaces B and D is 0.8, and the utility parameter of each of the parking spaces A and E is 1.0. Therefore, the average value of the utility parameters of this pattern is calculated as (1.0+0.8+0.8+1.0)/5=0.72.

Consider, for example, a case in which the number of remaining slots is three. In the pattern in which there are vehicles parked in the parking spaces A and C, the utility parameter of each of the parking spaces A and C is 0, the utility parameter of the parking space B is 0.2, the utility parameter of the parking space D is 0.8, and the utility parameter of the parking space E is 1.0. Therefore, the average value of the utility parameters of this pattern is calculated as (0.2+0.8+1.0)/5=0.4.

In the pattern in which there are vehicles parked in the parking spaces A and D, the utility parameter of each of the parking spaces A and D is 0, and the utility parameter of each of the parking spaces B, C, and E is 0.8. Therefore, the average value of the utility parameters of this pattern is calculated as (0.8+0.8+0.8)/5=0.48.

In the pattern in which there are vehicles parked in the parking spaces B and D, the utility parameter of each of the parking spaces B and D is 0, the utility parameter of the parking space C is 0.2, the utility parameter of each of the parking spaces A and E is 0.8. Therefore, the average value of the utility parameters of this pattern is calculated as (0.8+0.2+0.8)/5=0.36.

Consider, for example, a case in which the number of remaining slots is two. In the pattern in which there are vehicles parked in the parking spaces A, C, and E, the utility parameter of each of the parking spaces A, C, and E is 0 and the utility parameter of each of the parking spaces B and D is 0.2. Therefore, the average value of the utility parameters of this pattern is calculated as (0.2+0.2)/5=0.08.

In the pattern in which there are vehicles parked in the parking spaces A, C, and D, the utility parameter of each of the parking spaces A, C, and D is 0, the utility parameter of the parking space B is 0.2, and the utility parameter of the parking space E is 0.8. Therefore, the average value of the utility parameters of this pattern is calculated as (0.2+0.8)/5=0.2.

In the pattern in which there are vehicles parked in the parking spaces A, D, and E, the utility parameter of each of the parking spaces A, D, and E is 0, and the utility parameter of each of the parking spaces B and C is 0.8. Therefore, the average value of the utility parameters of this pattern is calculated as (0.8+0.8)/5=0.32.

In the pattern in which there are vehicles parked in the parking spaces A, B, and D, the utility parameter of each of the parking spaces A, B, and D is 0, the utility parameter of the parking space C is 0.2, and the utility parameter of the parking space E is 0.8. Therefore, the average value of the utility parameters of this pattern is calculated as (0.2+0.8)/5=0.2.

Consider, for example, a case in which the number of remaining slots is one. In the pattern in which there are vehicles parked in the parking spaces B, C, D, and E, the utility parameter of each of the parking spaces B, C, D, and E is 0, and the utility parameter of the parking space A is 0.8. Therefore, the average value of the utility parameters of this pattern is calculated as (0.8)/5=0.16.

In the pattern in which there are vehicles parked in the parking spaces A, C, D, and E, the utility parameter of each of the parking spaces A, C, D, and E is 0, and the utility parameter of the parking space B is 0.2. Therefore, the average value of the utility parameters of this pattern is calculated as (0.2)/5=0.04.

In the pattern in which there are vehicles parked in the parking spaces A, B, D, and E, the utility parameter of each of the parking spaces A, B, D, and E is 0, and the utility parameter of the parking space C is 0.2. Therefore, the average value of the utility parameters of this pattern is calculated as (0.2)/5=0.04.

Then, by calculating the average value of the utility of each pattern calculated for each pattern (average value of the utility parameters) in each of the remaining number of slots, the utility V_{P}(J) in the number of remaining slots J is obtained. Note that patterns that are symmetrical to each other are taken into account in this case. In the example shown in FIG. 4, V_{P}(5)=1.0. Further, V_{P}(4)=(0.76*2+0.72*2+0.72)/5≈0.74. Further, V_{P}(3)=(0.4*2+0.48*2+0.36)/5≈0.42. Further, V_{P}(2)=(0.08+0.2*2+0.32*2+0.2*2)/7≈0.22. Further, V_{P}(1)=(0.16*2+0.04*2+0.04)/5≈0.09. Further, V_{P}(0)=0.

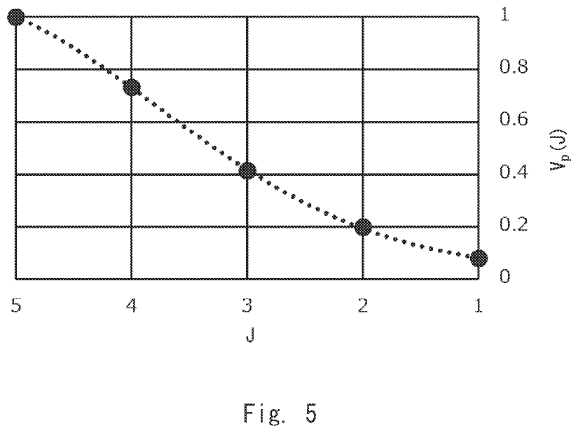

FIG. 5 is a diagram illustrating a graph of the utility function V_{P}(J) regarding ease of parking in the parking block utility function according to the first embodiment. In the graph shown in FIG. 5, the horizontal axis corresponds to the number of remaining slots J and the vertical axis corresponds to V_{P}(J). As shown in FIG. 5, the utility function V_{P}(J) regarding ease of parking decreases as J decreases. That is, the utility function V_{P}(J) regarding ease of parking is a monotonically increasing function for J.

The parking block selection unit 40 (FIG. 1) selects parking blocks 60 to be allocated to the plurality of respective vehicles based on the utility of each of the plurality of parking blocks 60 calculated by the parking block utility calculation unit 30. The parking block selection unit 40 may select, for example, the parking block 60 having the largest utility at this stage for the vehicle to be processed. Alternatively, the parking block selection unit 40 may select, for the vehicle to be processed, the parking blocks 60 probabilistically in such a way that parking blocks 60 with larger utilities have a higher probability of being selected (selection percentage) at this stage. The parking block selection unit 40 may select the parking blocks 60 by, for example, roulette wheel selection.

Further, the parking block selection unit 40 may select the parking blocks 60 to be allocated to the respective vehicles in accordance with the timing when each of the plurality of vehicles enters the parking lot 50 or before these vehicles enter the parking lot. Specifically, when the virtual parking lot 50 is managed, the parking block selection unit 40 may allocate, before a simulation is performed, the parking blocks 60 to the respective vehicles that will enter the parking lot 50 in the simulation. Alternatively, when the parking blocks 60 are allocated for a virtual parking lot 50 while a simulation is being performed, the parking block selection unit 40 may allocate the parking blocks 60 to the vehicles that are going to enter the parking lot 50 from the vehicle entrance/exit 52 in the simulation. A case in which the parking lot which is being designed will be operated in the future is assumed in the above situation. In this case, the parking block selection unit 40 predicts parking places selected by the respective vehicles (drivers of the respective vehicles). In the virtual space, the simulation is performed in such a way that the respective vehicles move to the predicted parking places. Further, when the parking lot 50 which is in operation is managed, the parking block selection unit 40 may allocate the parking blocks 60 to the vehicles that will enter the parking lot 50 from the vehicle entrance/exit 52 in reality. The same holds true for processing of selecting parking places in the other example embodiments that will be described later.

The parking block selection unit 40 may select the parking block 60 in accordance with, for example, the selection percentage Pⱼ expressed by the following Expression (4). In Expression (4), N denotes the total number of parking blocks 60. By selecting the parking block 60 in accordance with the selection percentage Pⱼ shown by Expression (4), the probability that a parking block 60 with a great utility is selected increases.

$$\begin{matrix}[ Expression 3 ] & \\ {P}_{j} = \frac{{V}_{j}}{{\sum }_{k = 1}^{N} {V}_{k}} & ( 4 )\end{matrix}$$

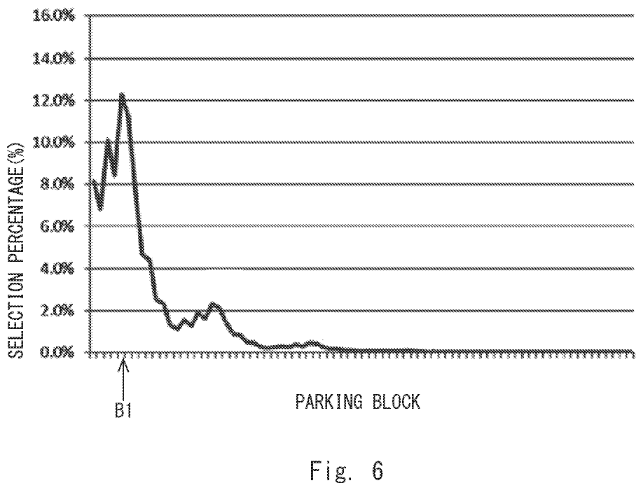

FIG. 6 is a graph illustrating the selection percentage according to the first embodiment. FIG. 6 illustrates the selection percentage of each of the parking blocks for the first vehicle. In the graph shown in FIG. 6, the horizontal axis indicates the parking block j and the vertical axis indicates the selection percentage Pⱼ. FIG. 6 does not correspond to the parking lot 50 illustrated in FIG. 2. In FIG. 6, the parking block j on the left side of the horizontal axis corresponds to a parking block that is substantially close to the vehicle entrance/exit. Then, the parking block shown by the arrow B1 is the parking block that is the closest to the walkway to the destination.

As shown in FIG. 6, for the first vehicle, the selection percentage of the parking blocks that are close to the vehicle entrance/exit and the walkway to the destination increases. Specifically, when a parking block for the first vehicle is selected, for all the parking blocks, the utility function V_{P}(J) in Expression (1) is 1.0. Therefore, when a parking block for the first vehicle is selected, the selection percentage may depend on the utility function V_{L}(L) in Expression (1). Therefore, when a parking block for the first vehicle is selected, the larger the value of the utility function V_{L}(L) in Expression (1) is, the higher the selection percentage becomes.

In the aforementioned Expression (1), unless the operation condition is changed, the value of the utility function V_{L}(L) remains unchanged even when the number of vehicles that are parked in the parking lot increases. On the other hand, the value of the utility function V_{P}(J) increases as the number of vehicles that are parked in the parking lot increases. In particular, since parking blocks with larger values of the utility function V_{L}(L) are more likely to be selected first, the value of the utility function V_{P}(J) may become small at an early stage. Therefore, as the processing of selecting vehicles proceeds and the number of vehicles that are parked in the parking lot increases, selection percentages of parking blocks with large values of the utility function V_{L}(L) may become low, and selection percentages of parking blocks with small values of the utility function V_{L}(L) may become high. Therefore, as the number of vehicles that are parked in the parking lot increases, the graph shown in FIG. 6 may be flat, and selection percentages of parking blocks with large number of remaining slots may become high. Therefore, it may be possible to prevent parking blocks having large utility functions V_{L}(L) regarding the position from being continuously selected. Then, it may be possible to prevent parking blocks with smaller number of remaining slots and smaller utility functions V_{P}(J) regarding ease of parking from being continuously selected. Therefore, the parking lot management system 1 according to the first embodiment is able to allocate the parking places (parking blocks) appropriately to the respective vehicles.

Further, as described above, the parking lot management system 1 according to the first embodiment is configured to allocate parking places to the vehicles by units of parking blocks, each including a plurality of parking spaces. Accordingly, it is possible to reduce the number of parking places to be allocated compared to the case in which parking places are allocated to vehicles by units of parking spaces. Therefore, it becomes possible to reduce the computation load compared to the case in which parking places are allocated to vehicles by units of parking spaces. In particular, even when the size of the parking lot is large and thus the number of parking spaces is enormous, it is possible to prevent the number of parking places to be allocated from being increased, whereby it is possible to prevent the computation load from being increased. Accordingly, with the parking lot management system 1 according to the first embodiment, it becomes possible to appropriately allocate parking places to respective vehicles while reducing the computation load.

One of the objects for managing a virtual parking lot may be prediction of a congestion (stacking) of vehicles in a parking lot. Further, one of the causes of a congestion in a parking lot may be stacking of subsequent vehicles due to the presence of a vehicle which is being parked. At this time, the subsequent vehicle may stop after the preceding vehicle by about several meters, that is, about the length corresponding to some parking spaces. Therefore, in order to express occurrence of stacking of vehicles, it is sufficient that the parking places to be allocated to the respective vehicles may be considered by units of parking blocks, not by units of parking spaces. In other words, even when the parking places to be allocated to the respective vehicles are considered by units of parking blocks, allocation (selection) in which behavior in an actual parking lot is reflected may be performed. The same holds true for a case of managing the parking lot which is in operation.

Further, in the parking lot management system 1 according to the first embodiment, the parking block selection unit 40 is configured to select parking blocks to be allocated to the plurality of respective vehicles in accordance with the timings when the plurality of respective vehicles enter the parking lot or before the vehicles enter the parking lot. Accordingly, it is possible to reduce the computation load compared to the method of selecting, after a vehicle has entered the parking lot, a parking place (moving destination) to be allocated to the vehicle while moving near the parking place. That is, in the processing of determining a parking place (moving destination) of a vehicle based on attractive values of parking spaces near the vehicle every time the vehicle moves inside the parking lot (e.g., for every time step in a simulation), the computation load becomes high. On the other hand, in the method according to the first embodiment, the parking block, that is, the moving destination, is selected (determined) in accordance with the timing when the vehicle enters the parking lot or before the vehicle enter the parking lot. Therefore, the processing of selecting a moving destination (parking block) is performed only once for each of the vehicles. Therefore, it becomes possible to further reduce the computation load.

Parking lots or the like attached to commercial facilities such as shopping malls are often provided with equipment that enables drivers or the like of vehicles to visually recognize the availability of each area in the parking lot when the vehicles enter the parking lot. Even in a parking lot that does not include this equipment, a driver of a vehicle may be able to assume, when he/she enters the parking lot, which area will be available for parking through experience, like in the case, for example, of an employee parking lot. It can therefore be said that selecting a parking block allocated to a vehicle in accordance with the timing when the vehicle enters the parking lot reflects behavior in an actual parking lot.

Now, parameters included in the parking block utility function shown in Expression (1) will be described. The parameter β is a parameter for adjusting the utility by the time element L regarding the corresponding parking block. As β becomes larger, V_{L}(L) is significantly decreased in accordance with the increase in the time element L. Therefore, as β becomes larger, the utility that the value of time increases is obtained. Therefore, as β becomes larger, the utilities of the parking blocks 60 near the vehicle entrance/exit 52 or the walkway to the destination 54 may be large. Therefore, when β increases, the probability that a parking block 60 which is near the vehicle entrance/exit 52 or the walkway to the destination 54 is selected may become high.

Further, the parameter c is a parameter that corresponds to the weight (penalty) of the travelling time of the vehicle. As c becomes larger, V_{L}(L) is significantly decreased (since L is significantly increased) along with the increase in the travelling time of the vehicle. Therefore, as c becomes larger, the utility that the value of the travelling time of the vehicle increases is obtained. Therefore, as c becomes larger, the utilities of the parking blocks 60 near the vehicle entrance/exit 52 may be large. Therefore, when c increases, the probability that a parking block 60 which is near the vehicle entrance/exit 52 is selected may become high.

Further, the parameter w is a parameter that corresponds to the weight (penalty) of the walking time. As w becomes larger, V_{L}(L) is significantly decreased (since L is significantly increased) along with the increase in the walking time. Therefore, as w becomes larger, the utility that the value of the walking time increases is obtained. Therefore, as w becomes larger, the utilities of the parking blocks 60 near the walkway to the destination 54 may be large. Therefore, when w increases, the probability that a parking block 60 which is near the walkway to the destination 54 is selected may become high.

Further, the parameters dᵢ and dₒ are, respectively, a parameter that corresponds to the weight with respect to the travelling time at the time of entrance (at the time of travelling to the destination) of the travelling time of the vehicle, and a parameter that corresponds to the weight with respect to the travelling time at the time of exit (at the time of leaving the destination) of the travelling time of the vehicle. As dᵢ becomes larger, V_{L}(L) is significantly decreased (since L is significantly increased) along with the increase in the travelling time at the time of entrance. Therefore, as dᵢ becomes larger, the utility that the value of the travelling time at the time of entrance increases is obtained. Therefore, as dᵢ becomes larger, the utility of a parking block 60 (e.g., the parking block 60 of the parking block number #14 shown in FIG. 2) where the travelling distance (travelling time) after the vehicle enters from the vehicle entrance/exit 52 is short may be large. Therefore, when dᵢ increases, the probability that a parking block 60 where the travelling distance (travelling time) after the vehicle enters is short is selected may become high.

On the other hand, as dₒ becomes larger (as dᵢ becomes smaller), V_{L}(L) is significantly decreased (since L is significantly increased) along with the increase in the travelling time at the time of exit. Therefore, as dₒ becomes larger, the utility that the value of the travelling time at the time of exit increases is obtained. Therefore, as dₒ becomes larger, the utility of the parking block 60 (e.g., the parking block 60 of the parking block number #13 in FIG. 2) where the travelling distance (travelling time) before the vehicle exits from the vehicle entrance/exit 52 is short may be large. Therefore, when dₒ increases, the probability that a parking block 60 where the travelling distance (travelling time) before the vehicle exits is short is selected may become high.

Further, the parameters p₁ and p₂ are parameters regarding the utility in a case in which, for each of the parking spaces 56 of the parking block 60, there is a parked car in a parking space 56 that is adjacent to the above parking space 56. As p₁ and p₂ become smaller, V_{P}(J) is significantly decreased in accordance with the decrease in the number of remaining slots J. Therefore, as p₁ and p₂ become smaller, the utility that the value of the number of remaining slots J increases is obtained. In other words, as p₁ and p₂ become smaller, users tend to be reluctant to park their vehicles in a parking space 56 that is adjacent to the parking space 56 where a vehicle is parked. Therefore, as p₁ and p₂ become smaller, the utility by the parking block utility function Vᵢ shown in Expression (1) is significantly decreased if the number of remaining slots J decreases even when a parking block 60 has a large value (utility) of the utility function V_{L}(L). Therefore, when p₁ and p₂ decrease, the probability that a parking block 60 other than the parking block 60 having a large value (utility) of the utility function V_{L}(L) is selected increases. In other words, when p₁ and p₂ decrease, the probability that parking blocks 60 that are located in various parts of the parking lot are selected increases, rather than parking blocks 60 located in only a limited part of the parking lot being locally selected.

As described above, the parameters β, c, w, dᵢ, p₁, and p₂ in the parking block utility function shown in Expression (1) may vary in accordance with the operation condition of the parking lot. That is, parameters included in the parking block utility function may be adapted in accordance with the operation condition of the parking lot. Accordingly, as will be described later, it becomes possible to select (allocate) the parking block (parking place) that matches the actual user's preference corresponding to the operation condition of the parking lot. Therefore, when the parking lot managed by the parking lot management system 1 is the one in a virtual space, it is possible to improve the accuracy of the prediction of selection of the parking place and the accuracy of the simulation. Further, when the parking lot managed by the parking lot management system 1 is an actual one, it becomes possible to select (allocate) parking blocks that are easily accepted by users.

The operation condition includes at least one of the type of the parking lot, the time zone, the season, and the weather. The “type of the parking lot” includes the structure of the parking lot, and the type of the facility (i.e., destination) to which the parking lot is attached. The structure of the parking lot includes information indicating whether or not this parking lot is a multistory parking lot, information on the size of the parking lot, and information indicating whether or not there is a roof. The type of the facility (destination) includes, for example, a commercial facility such as a shopping mall or a department store, and an office building where a driver or the like who uses the corresponding parking lot works.

When, for example, the operation condition is “for an uncovered outdoor parking lot, weather is bad”, it can be considered that users tend to prefer a short walking time. Therefore, parameters may be adapted in such a way that the parameter w increases under this condition. Accordingly, the parking block selection unit 40 may select a parking block that matches the user's preference that he/she prefers a short walking time.

Further, when the operation condition is a condition “for a parking lot attached to a large-scale shopping mall, daytime hours”, it can be considered that users tend to prefer a short walking time since users visit there for the purpose of shopping and thus normally carries many things. Therefore, under this condition, parameters may be adapted in such a way that the parameter w increases. Accordingly, the parking block selection unit 40 may select a parking block that matches the user's preference that he/she prefers a short walking time.

On the other hand, when the operation condition is a condition “for a parking lot attached to a large-scale shopping mall, nighttime hours”, users often visit there for the purpose of watching movies in a movie theater or dining at restaurants. In this case, it can be considered that users tend to prefer a short travelling time to the vehicle entrance/exit 52 in order to avoid a congestion of vehicles in the parking lot just before the closing time. Therefore, parameters may be adapted in such a way that the parameter dₒ increases under this condition. Accordingly, the parking block selection unit 40 may select a parking block that matches the user's preference that he/she prefers a short travelling time to the vehicle entrance/exit 52.

Further, when the operation condition is a condition “an employee parking lot of an office building”, each of users may not feel uncomfortable for parking his/her car in a parking space 56 that is adjacent to the parking space 56 where a vehicle has already been parked. Therefore, under this condition, parameters may be adapted in such a way that the parameters p₁ and p₂ increase. Accordingly, the parking block selection unit 40 may select a parking block that matches the user's preference that he/she does not feel uncomfortable for parking his/her vehicle in a parking space 56 that is adjacent to the parking space 56 where a vehicle has already been parked.

Further, when the operation condition is a condition “for an employee parking lot of an office building, a time before the beginning of working hours”, users often leave their office all together at the end of working hours. Therefore, it can be considered that the users tend to prefer a short travelling time to the vehicle entrance/exit 52 in order to avoid a congestion of vehicles in the parking lot when they leave their office. Therefore, under this condition, parameters may be adapted in such a way that the parameter dₒ increases. Accordingly, the parking block selection unit 40 may select a parking block that matches the user's preference that he/she prefers a short travelling time to the vehicle entrance/exit 52.

Further, when the operation condition is a condition “a parking lot where it is difficult for users to drive their vehicles”, it can be considered that users tend to prefer a short travelling time of the vehicle. Therefore, under this condition, parameters may be adapted in such a way that the parameter c increases. Accordingly, the parking block selection unit 40 may select a parking block that matches the user's preference that he/she prefers a short travelling time.

Further, even in the same parking lot, if the date (day of the week etc.), the season, and the weather vary, the user's preference may vary as well. When, for example, the parking lot is an outdoor parking lot, users tend to prefer a short walking time if it rains (or in a case of extreme heat or extreme cold weather). On the other hand, if it is fine (or in a case of a pleasant weather), users usually do not tend to prefer a short walking time. Likewise, even in the same parking lot, the user's preference may vary in accordance with the time zone.

In this way, the utility of each of the parking blocks 60 in the parking lot 50 may change in accordance with the operation condition. Then, in the parking lot management system 1 according to the first embodiment, parameters included in the parking block utility function are adapted in accordance with the operation condition of the parking lot. In particular, parameters included in the parking block utility function are adapted in accordance with at least one of the type of the parking lot, the time zone, the season, and the weather. That is, in the parking lot management system 1 according to the first embodiment, the parameters included in the parking block utility function may vary in accordance with the operation condition. For example, even in the same parking lot, parameters to be adapted when it rains may be different from parameters to be adapted when it is fine. Therefore, the parking lot management system 1 according to the first embodiment may change the parameters included in the parking block utility function as appropriate in accordance with the operation condition. In this case, the parking lot management system 1 may acquire information indicating the operation condition (e.g., weather, time zone or the like) and automatically change the parameters. Accordingly, the parking lot management system 1 according to the first embodiment is able to select a parking block that matches the preference of the actual user.

Further, as described above, the parking block utility calculation unit 30 according to the first embodiment is configured to calculate the utility in accordance with the number of parking spaces in a parking block where no vehicles are parked (the number of remaining slots J). In particular, the parking block utility calculation unit 30 according to the first embodiment is configured to calculate the utility using the utility function (V_{P}(J)) whose value decreases as the number of parking spaces in the parking block where no vehicles are parked (the number of remaining slots J) decreases. In general, the utility of a parking space that is adjacent to a parking space in a case in which a vehicle is stopped in this parking space may be different from the utility of a parking space that is adjacent to the above parking space in a case in which there is no vehicle in this parking space. Specifically, it is highly likely that the difficulty that a user parks his/her vehicle in a parking space that is adjacent to the parking space where a vehicle is parked may be generally higher than the difficulty that a user parks his/her vehicle in a parking space that is adjacent to the parking space where there is no vehicle. Therefore, regarding the utility in accordance with ease of parking, it is highly likely that the utility of a parking space that is adjacent to the parking space where a vehicle is parked may become smaller than the utility of a parking space that is adjacent to the parking space where there is no vehicle.

Therefore, when the utility in accordance with ease of parking is taken into account regarding a parking block, if the number of remaining slots decreases, besides the number of parking spaces where vehicles are parked, the number of parking spaces that are adjacent to parking spaces where vehicles are parked may increase as well. Therefore, when the number of remaining slots J decreases, the utility in accordance with ease of parking regarding the parking block may decrease. Then, managing the number of remaining slots in a parking block may be easier and simpler than managing which parking space in the parking block a vehicle is parked. When, for example, the parking lot to be managed is a virtual one, after one parking block is selected, it is sufficient that the number of remaining slots of the selected parking block be decreased by one. That is, it is not necessary to take into account which parking space in the parking block a vehicle should be parked. Further, when the parking lot to be managed is an actual one, it is sufficient that the number of remaining slots in a parking block be acquired as a parking lot condition and it is not necessary to take into account which parking spaces in the parking block vehicles are parked. Therefore, the parking lot management system 1 according to the first embodiment is configured to calculate the utility in accordance with the number of remaining slots in a parking block, whereby it becomes possible to select a parking block that matches the preference of the actual user by simple processing.

When the parking lot management system 1 manages a parking lot (a multistory parking lot etc.) including a plurality of parking floors, the plurality of parking floors may be collectively considered and the aforementioned parking block utility function may be calculated for each of the parking blocks included in the plurality of parking floors. Note that the method of calculating the utility function separately for each of the plurality of floors will be described in the other embodiments that will be described later.

### Second Embodiment

Next, with reference to the drawings, a second embodiment will be described. For the sake of clarification of the description, the following descriptions and the drawings are omitted and simplified as appropriate. Further, throughout the drawings, the same elements are denoted by the same reference symbols and the overlapping descriptions will be omitted as appropriate. The configuration of a parking lot management system 1 according to the second embodiment corresponds to a more specific configuration of the parking lot management system 1 shown in the first embodiment.

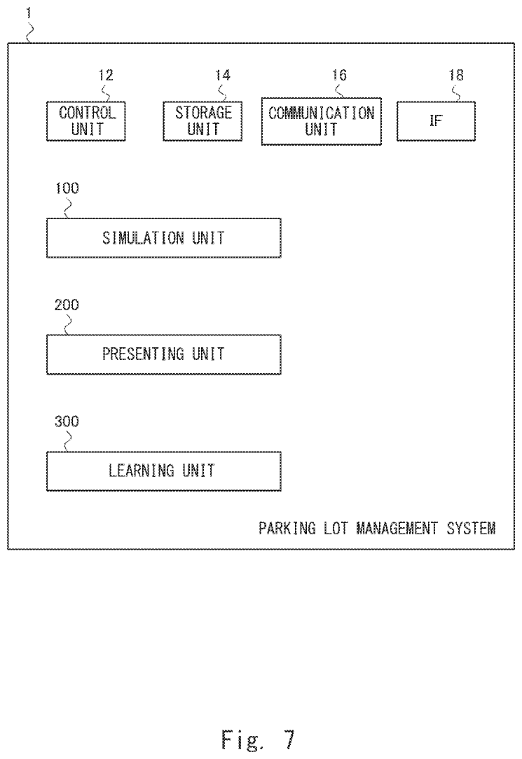

FIG. 7 is a diagram showing a configuration of the parking lot management system 1 according to the second embodiment. The parking lot management system 1 according to the second embodiment includes, as main hardware configurations, the control unit 12, the storage unit 14, the communication unit 16, and the interface unit 18 described above. The parking lot management system 1 according to the second embodiment further includes, as components, a simulation unit 100, a presenting unit 200, and a learning unit 300.

The simulation unit 100, the presenting unit 200, and the learning unit 300 may be configured as hardware apparatuses separated from one another. In this case, the simulation unit 100 functions as a simulation apparatus. Further, the presenting unit 200 functions as a presenting apparatus. Further, the learning unit 300 functions as a learning apparatus. Further, in this case, the simulation unit 100, the presenting unit 200, and the learning unit 300 may respectively include the control unit 12, the storage unit 14, the communication unit 16, and the interface unit 18.

The simulation unit 100 performs processing for managing a virtual parking lot. The simulation unit 100 allocates parking places to virtual vehicles that enter the virtual parking lot. Then, the simulation unit 100 performs control in such a way that the vehicles move to moving destinations, which are the allocated parking places, in a simulation. Assume here that a parking lot which is being designed will be operated in the future. In this case, the simulation unit 100 predicts parking places selected by the respective vehicles (drivers of the respective vehicles). Then, the simulation unit 100 performs the simulation in such a way that the respective vehicles move to the predicted parking places in the virtual space. The details thereof will be described later.

The presenting unit 200 performs processing for managing the parking lot that exists in reality and is in operation. The presenting unit 200 allocates a parking place to an actual vehicle at a timing when the actual vehicle enters the parking lot that exists in reality. Then, the presenting unit 200 performs control to present (recommend) the parking place allocated to this vehicle for the vehicle (occupant of the vehicle). Accordingly, it is possible to let this vehicle move to the parking place. The details thereof will be described later. It can also be said that the presenting unit 200 predicts parking places that may be acceptable by actual vehicles (drivers etc.)

The learning unit 300 sets parameters included in the utility function used to allocate the parking places by learning. The learning unit 300 performs processing so as to adapt parameters in accordance with the various operation conditions in a parking lot. The details thereof will be described later.

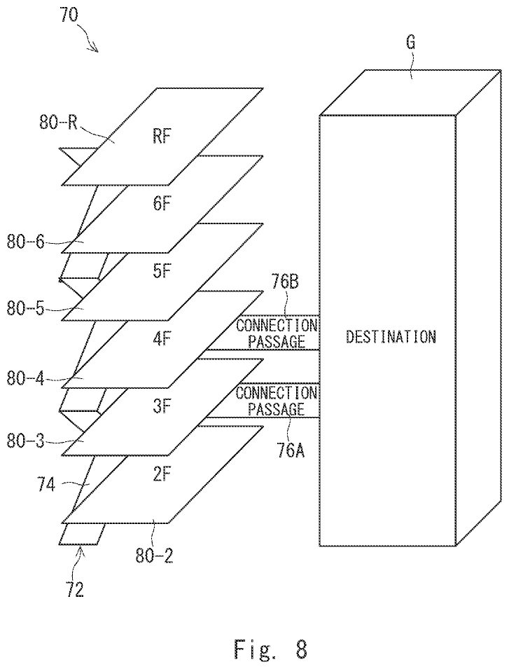

FIG. 8 is a diagram illustrating the parking lot 70 managed by the parking lot management system 1 according to the second embodiment. The parking lot 70 may either be a virtual one or may be the one actually operated. The parking lot 70 illustrated in FIG. 8 is a flat multistory parking lot that includes a plurality of parking floors 80. The parking lot 70 illustrated in FIG. 8 includes parking floors 80-2 to 80-6 on the second floor to the sixth floor (2F to 6F) and a parking floor 80-R on the rooftop floor (RF).

The parking lot 70 includes a slope 74 so as to enable vehicles to move to a parking floor 80 located on the upper or lower floor. A slope entrance/exit 72 is provided as an entrance/exit of the parking lot 70 on the boundary between the slope 74 and the ground floor (road). The vehicles are able to enter the parking lot 70 from the slope entrance/exit 72, travel along the slope 74 upwardly, and move to the parking floor 80 on the upper floor. The slope 74 has a configuration that is independent from the parking floor 80. Therefore, when a vehicle moves between parking floors 80, the vehicle may not travel in the parking floor 80. Further, the entrance and the exit of the parking lot 70 may be separated from each other. In this case, a plurality of the slope entrance/exits 72 may be provided.

The structure of each of the parking floors 80 may be substantially similar to that of the parking lot 50 illustrated in FIG. 2. That is, each of the parking floors 80 includes parking blocks 60, each formed of a plurality of parking spaces 56. Further, the boundary between each of the parking floors 80 and the slope 74 corresponds to the vehicle entrance/exit of each of the parking floors 80. That is, the vehicle entrance/exit 52 of the parking lot 50 illustrated in FIG. 2 corresponds to the vehicle entrance/exit in each of the parking floors 80. Further, the walkway to the destination 54 illustrated in FIG. 2 corresponds to the entrance/exit for pedestrians of each of the parking floors 80. Further, the parking lot 70 is provided with a raising and lowering equipment so as to enable a pedestrian (occupant) who has exited from the parking floor 80 through the entrance/exit for pedestrians to move between parking floors 80. The raising and lowering equipment is, for example, stairs, an elevator, or an escalator. The entrance/exit for pedestrians may be provided in the raising and lowering equipment.

Further, a connection passage 76 that connects a predetermined floor of a destination G having a multistory structure with a predetermined parking floor 80 is provided in the parking lot 70. In the example shown in FIG. 8, connection passages 76A and 76B are provided in the parking floor 80-3 on the third floor and the parking floor 80-4 on the fourth floor. An occupant of a vehicle that has been parked in a parking floor 80 where there is no connection passage 76 can move to the parking floor 80 where the connection passage 76 is provided using the raising and lowering equipment, walk along the connection passage 76, and reach the destination G. For example, an occupant of a vehicle that has been parked on the parking floor 80-5 on the fifth floor can go down to the parking floor 80-4 on the fourth floor using the raising and lowering equipment, walk along the connection passage 76B, and reach the destination G. Therefore, it can be said that predetermined parking floors 80 (parking floors 80-3 and 80-4) where the connection passages 76 are provided are target floors for the occupants in the parking lot 70. When a connection passage is not provided in the parking lot 70, the target floor may be a floor such as a first level floor where occupants can access the entrance/exit of the destination G.

In the parking lot management system 1 according to the second embodiment, besides the parking blocks 60, the parking floors 80 are allocated (selected) to the vehicles. That is, the parking lot management system 1 according to the second embodiment allocates, to a vehicle that has entered the parking lot 70, the parking floor 80 where the vehicle should be parked, and further allocates a parking block 60 on the allocated parking floor 80. The details thereof will be described later.

In the parking lot management system 1 according to the second embodiment, the parking floor utility function used when the parking floor 80 is selected for each of the vehicles will be described. The parking lot management system 1 according to the second embodiment calculates the utility of each of the plurality of parking floors 80 using the parking floor utility function. Then, the parking lot management system 1 according to the second embodiment selects the parking floors 80 allocated to the respective vehicles, that is, the parking floors 80 to which the vehicles will move using the utility of each of the plurality of parking floors 80 that has been calculated.

The parking floor utility function is a utility function set in advance regarding the parking floor 80. The parking floor utility function is a function of expressing the utility (degree of attractiveness) of the corresponding parking floor 80 for a vehicle (occupant). That is, the utility of the parking floor 80 corresponds to the value of the utility function regarding the parking floor 80.

The parking floor utility function may be expressed in accordance with the travelling time of the vehicle between the parking floor 80 and the slope entrance/exit 72, the walking time (moving time) of the occupant between the parking floor 80 and the destination G, and ease of finding an available parking space on the parking floor 80. The reference point of the parking floor 80 when the travelling time is defined may be, for example, a point at the boundary between the parking floor 80 and the slope 74. The reference point of the parking floor 80 when the walking time is defined may be, for example, the position of the raising and lowering equipment on the parking floor 80. The travelling time of the vehicle may be defined in accordance with the travelling time from the slope entrance/exit 72 to the reference point of the parking floor 80 at the time of entrance, and the travelling time from the reference point of the parking floor 80 to the slope entrance/exit 72 at the time of exit. Likewise, the occupant's walking time may be defined in accordance with the raising and lowering time between the reference point of the parking floor 80 and the target floor in the raising and lowering equipment and the walking time between the raising and lowering equipment and the destination G in the target floor. Further, the ease of finding an available parking space of the parking floor 80 may be defined in accordance with the number of vehicles that have already been parked in one of the parking spaces 56 (the number of vehicles that are parked) on the parking floor 80. In other words, ease of finding an available parking space on the parking floor 80 may be defined in accordance with the number of parking spaces 56 on the parking floor 80 where there are no vehicles parked yet (the number of remaining slots).

Assume that f is an index indicating the parking floor number (floor number). Then, the parking floor utility function V_{f} regarding the parking floor number #f may be expressed, for example, by the following Expression (5).

[Expression 4]

V_{f}=V_{L}(L)·V_{O}(O_{f}) (5)

In Expression (5), V_{L}(L) is a utility function that expresses the utility in accordance with the position (distance) of the parking floor 80. In other words, V_{L}(L) is a utility function expressed by the travelling time of the vehicle and the occupant's walking time. That is, V_{L}(L) is a utility function regarding the time element (position).

The utility function V_{L}(L) regarding the time element may be expressed, for example, by the following Expression (6).

[Expression 5]

V_{L}(L)=αe^{-Lβ}α,β>0 (6)

The symbols α and β are parameters in the utility function (utility function parameters). The symbols a and β are parameters having functions that are substantially similar to those of a and β, respectively, in the aforementioned Expression (2). The symbols a and β in Expression (6) may be the same values as a and β, respectively, in the aforementioned Expression (2). The symbol β may be set, for example, by learning in a predetermined operation condition in advance. That is, β may be adapted in accordance with the operation condition of the parking lot. That is, β may vary in accordance with the operation condition of the parking lot. In other words, β may vary if the operation condition of the parking lot varies.

Further, the time element L may be expressed, for example, by the following Expression (7).

L=c·(travelling time of the vehicle)+s·(raising and lowering time to the target floor)+w·(walking time from the target floor to the destination) (7)

In Expression (7), c, s, and w are parameters in the utility function (utility function parameters). The symbol c is a parameter that corresponds to the weight of the travelling time of the vehicle. The symbol s is a parameter that corresponds to the weight of the raising and lowering time. The symbol w is a parameter that corresponds to the weight of the walking time. The symbol s may be defined in advance or may be set by learning. The symbols c and w may be set by, for example, learning in a predetermined operation condition in advance. That is, c and w may be adapted in accordance with the operation condition of the parking lot. That is, c and w may vary in accordance with the operation condition of the parking lot. In other words, c and w may vary if the operation condition of the parking lot varies. The details thereof will be described later.

Further, the time element L corresponds to the travelling time of the vehicle, that is, the distance between the corresponding parking floor 80 and the slope entrance/exit 72, the raising and lowering time, and the walking time, that is, the distance between the target floor and the destination G. Further, when the entrance and the exit of the parking lot 70 are separated from each other, the “travelling time of the vehicle” is obtained by dividing a weighted average of the travelling distance from the slope entrance/exit 72 to the reference point of the parking floor 80 at the time of entrance and the travelling distance from the reference point of the parking floor 80 to the slope entrance/exit 72 at the time of exit by the travelling speed of the vehicle. Assume here that the weight with respect to the travelling distance at the time of entrance is denoted by dᵢ and the weight with respect to the travelling distance at the time of exit is denoted by dₒ. Here, dₒ=1−dᵢ>0. The symbols dᵢ and dₒ are parameters in the utility function (utility function parameters). The symbols dᵢ and dₒ may be set by, for example, learning in a predetermined operation condition in advance. That is, dᵢ and dₒ may be adapted in accordance with the operation condition of the parking lot. That is, dᵢ and dₒ may vary in accordance with the operation condition of the parking lot. In other words, dᵢ and dₒ may vary if the operation condition of the parking lot varies. The details thereof will be described later. The symbols dᵢ and dₒ may be respectively the same as dᵢ and dₒ that are used to calculate L in the aforementioned Expression (3).

Further, the “raising and lowering time” may be obtained, for example, from the difference between the level of the corresponding parking floor 80 and the level of the target floor. When the raising and lowering equipment is an elevator, the raising and lowering time may include an average waiting time for an elevator. When the raising and lowering equipment is stairs, the raising and lowering time may be obtained from the number of steps in the stairs between the corresponding parking floor 80 and the target floor. Further, the “walking time from the target floor to the destination” is obtained by dividing the walking distance between the raising and lowering equipment in the target floor, the connection passage 76, and the destination G by the walking speed.

If the operation condition is the same, c and w in Expression (7) may be the same values as c and w in the aforementioned Expression (3), respectively. That is, if the operation condition is the same, it may be considered that the weight of the travelling time of the vehicle and the weight of the walking time when a parking floor is selected is substantially the same as the weight of the travelling time of the vehicle and the weight of the walking time when a parking block is selected. Therefore, it can be considered that common c and w may be set in both the parking block utility function and the parking floor utility function. The same holds true for dᵢ and dₒ.

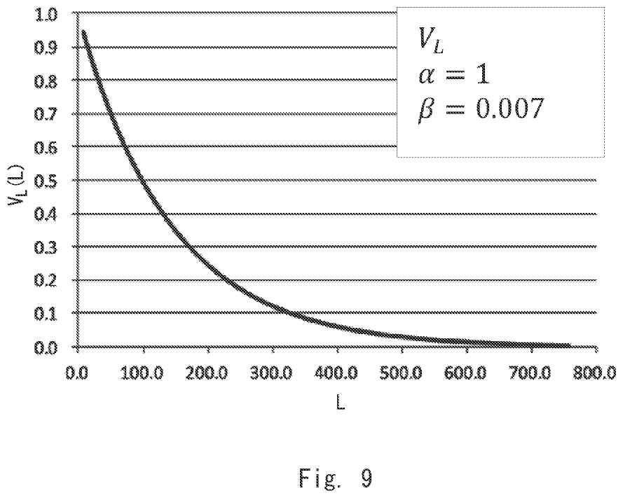

FIG. 9 is a diagram illustrating a graph of the utility function V_{L}(L) regarding the time element in the parking floor utility function according to the second embodiment. In the graph shown in FIG. 9, the horizontal axis corresponds to L in Expression (6) and the vertical axis corresponds to V_{L}(L) in Expression (6). The graph shown in FIG. 9 is a graph when α=1 and β=0.007. As shown in FIG. 9, the utility function V_{L}(L) regarding the time element decreases as L increases. That is, the utility function V_{L}(L) regarding the time element in the parking floor utility function is a monotonically decreasing function for L.

Further, in Expression (5), V_{O}(O_{f}) is a utility function that expresses the utility in accordance with ease of finding an available parking space on the parking floor 80. The symbol O_{f} in V_{O}(O_{f}) indicates the number of parking spaces 56 in the parking floor number #f where vehicles are not parked (the number of remaining slots). The symbol V_{O}(O_{f}) may be a function whose value decreases as O_{f} decreases.

The utility function V_{O}(O_{f}) regarding ease of finding an available parking space may be expressed, for example, by the following Expression (8).

[Expression 6]

V_{O}(O_{f})=1−e^{-O}^{_{f}}^{γ} (8)

In Expression (8), γ is a parameter in the utility function (utility function parameter). The symbol γ may be set by, for example, learning in a predetermined operation condition in advance. That is, γ may be adapted in accordance with the operation condition of the parking lot. That is, γ may vary in accordance with the operation conditions of the parking lot. In other words, γ may vary if the operation condition of the parking lot varies.

Here, the parameter γ is a parameter for adjusting the utility by the number of remaining slots O_{f} regarding the corresponding parking floor. As γ becomes smaller, V_{O}(O_{f}) is significantly decreased in accordance with the decrease in the number of remaining slots O_{f}. Therefore, as γ becomes smaller, the utility that the value of the number of remaining slots increases is obtained. Therefore, as γ becomes smaller, the probability that the corresponding parking floor is selected may be significantly reduced in accordance with the decrease in the number of remaining slots. On the other hand, as γ increases, even when the number of remaining slots decreases, it is possible to prevent the probability that the corresponding parking floor is selected from being too low.

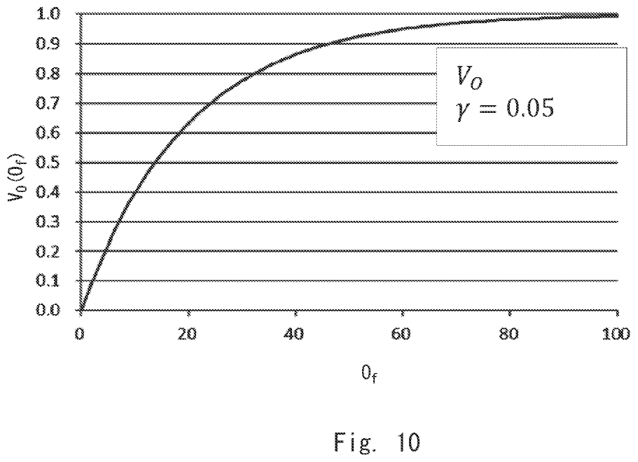

FIG. 10 is a diagram illustrating a graph of the utility function V_{O}(O_{f}) regarding ease of finding an available parking space in the parking floor utility function according to the second embodiment. In the graph shown in FIG. 10, the horizontal axis corresponds to O_{f} in Expression (8) and the vertical axis corresponds to V_{O}(O_{f}) in Expression (8). The graph shown in FIG. 10 is a graph when γ=0.05. As shown in FIG. 10, the utility function V_{O}(O_{f}) regarding ease of finding an available parking space decreases as O_{f} decreases. That is, the utility function V_{O}(O_{f}) regarding ease of finding an available parking space in the parking floor utility function is a monotonically increasing function for Of.

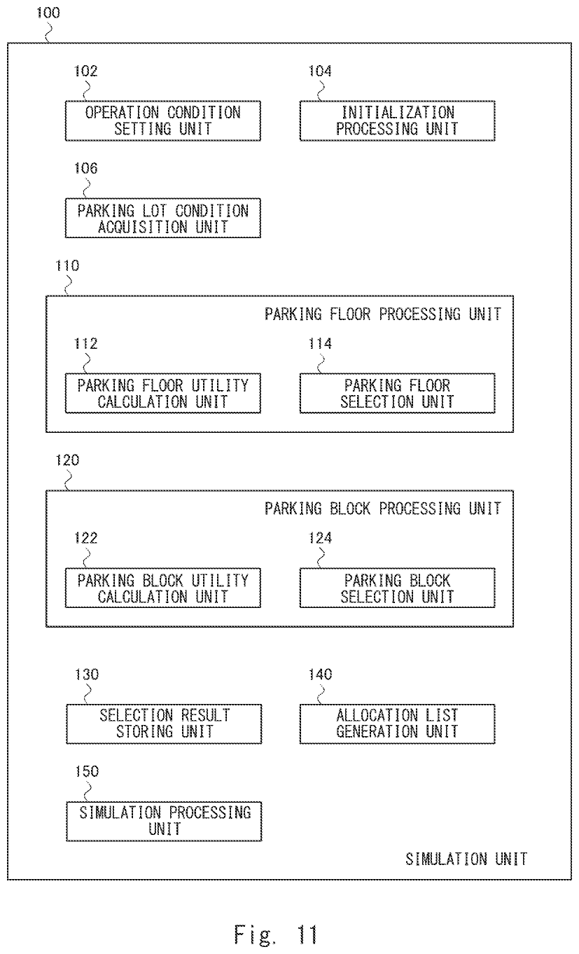

FIG. 11 is a diagram showing a configuration of the simulation unit 100 according to the second embodiment. The simulation unit 100 includes an operation condition setting unit 102, an initialization processing unit 104, a parking lot condition acquisition unit 106, a parking floor processing unit 110, a parking block processing unit 120, a selection result storing unit 130, an allocation list generation unit 140, and a simulation processing unit 150. The parking floor processing unit 110 includes a parking floor utility calculation unit 112 and a parking floor selection unit 114. The parking block processing unit 120 includes a parking block utility calculation unit 122 and a parking block selection unit 124.

The operation condition setting unit 102 sets operation conditions when a simulation is performed. The operation condition setting unit 102 may set the operation conditions by, for example, receiving input information obtained by an operator operating the interface unit 18. Alternatively, the operation condition setting unit 102 may set the operation conditions by reading operation conditions stored in advance. For example, the operation condition setting unit 102 may set operation conditions like “type of the parking lot: a six-story flat parking lot attached to a shopping mall, time zone: morning, season: winter, weather: fine”. Alternatively, the operation condition setting unit 102 may set operation conditions like “type of the parking lot: a three-story flat parking lot for employees, time zone: time when employees come to work, season: spring, weather: rain”.

The initialization processing unit 104 performs initialization processing of various kinds of setting when the simulation is performed. That is, the initialization processing unit 104 sets various kinds of parameters used when the parking floors 80 and the parking blocks 60 are selected. The initialization processing unit 104 may perform initialization processing by receiving, for example, input information obtained by the operator operating the interface unit 18. Alternatively, the initialization processing unit 104 may perform initialization processing by reading parameters stored in advance. The initialization processing may include, for example, parking lot object initialization, agent object initialization, and utility calculation object initialization.

In the parking lot object initialization, the initialization processing unit 104 sets structural data of the parking lot 70 to be simulated that corresponds to the type of the parking lot set in the operation conditions. Further, the initialization processing unit 104 sets the travelling distance and the walking distance regarding each of the parking blocks 60 of the parking lot 70. Further, the initialization processing unit 104 sets the travelling distance from the slope entrance/exit 72 to each of the parking floors 80, the moving distance in the raising and lowering equipment from each of the parking floors 80 to the target floor, and the walking distance from the raising and lowering equipment to the destination G.

In the agent object initialization, the initialization processing unit 104 sets the travelling speed of the vehicle and the walking speed of the pedestrian. Further, the initialization processing unit 104 may set the raising and lowering speed of the pedestrian in the raising and lowering equipment, which is stairs. Further, the initialization processing unit 104 sets a parking demand (the number of vehicles that are expected to enter the parking lot 70) for each predetermined time in the set time zone in the set operation conditions. When, for example, the set time zone is a “time when employees come to work”, the parking demand corresponds to the number of vehicles that are expected to enter the parking lot every 15 minutes from 7:00 to 10:00 (e.g., 10 vehicles from 7:00 to 7:15 and 15 vehicles from 7:15 to 7:30). The parking demand may be determined as appropriate by operators or the like who operate the parking lot 70. Further, it may be assumed that a plurality of vehicles have already been parked in the parking lot 70 at the initial stage of the simulation. In this case, the initialization processing unit 104 may set the number of vehicles that are parked in each of the parking floors 80 (or the number of remaining slots) and the number of vehicles that are parked in each of the parking blocks 60 (or the number of remaining slots) in the agent object initialization.

In the utility calculation object initialization, the initialization processing unit 104 sets parameters of the parking block utility function adapted to the set operation conditions. The initialization processing unit 104 further calculates, for each of the parking blocks 60, the time element L shown in Expression (3), and the utility function V_{L}(L) regarding the time element L shown in Expressions (1) and (2) using the set parameters of the utility function. The initialization processing unit 104 further calculates, for each of the parking blocks 60, the initial value of the utility function V_{P}(J) representing the utility in accordance with ease of parking shown in Expression (1).

Further, in the utility calculation object initialization, the initialization processing unit 104 sets the parameters of the parking floor utility function adapted to the set operation conditions. Further, the initialization processing unit 104 calculates, for each of the parking floors 80, the time element L shown in Expression (7), and the utility function V_{L}(L) regarding the time element L shown in Expressions (5) and (6) using the set parameters of the utility function. The initialization processing unit 104 further calculates, for each of the parking blocks 60, the initial value of the utility function V_{O}(O_{f}) regarding ease of finding an available parking space shown in Expressions (5) and (8).

The parking lot condition acquisition unit 106 corresponds to the parking lot condition acquisition unit 20 shown in FIG. 1. The parking lot condition acquisition unit 106 acquires the parking lot condition in the parking lot 70 to be simulated. Specifically, the parking lot condition acquisition unit 106 acquires, in the middle of allocating the current parking places (the parking floors 80 and the parking blocks 60), information (parking lot condition information) indicating how many vehicles are allocated for each of the parking floors 80 of the parking lot 70. That is, the parking lot condition acquisition unit 106 acquires information indicating how many vehicles each of the parking floors 80 is allocated to. In other words, the parking lot condition acquisition unit 106 acquires, in the middle of allocating the current parking place, information (parking lot condition information) indicating how many vehicles are allocated to each of the parking blocks 60 of the parking lot 70. That is, the parking lot condition acquisition unit 106 acquires information indicating how many vehicles each of the parking blocks 60 is allocated to. The parking lot condition acquisition unit 106 is able to acquire the parking lot condition from data indicating the results of selecting the parking floors 80 and the parking blocks 60 stored in the selection result storing unit 130 that will be described later.

The parking floor processing unit 110 performs processing for allocating, for each of the vehicles, the parking floor 80 where the vehicle should be parked. Assume here that a parking lot which is being designed will be operated in the future. In this case, the parking floor processing unit 110 predicts the parking floors 80 selected by the respective vehicles (drivers of the respective vehicles). That is, the parking floor processing unit 110 allocates the parking floors 80 where it is predicted that the respective vehicles will be parked to the respective vehicles. In other words, the parking floor processing unit 110 selects the parking floors 80 where it is predicted that the respective vehicles will be parked.

The parking floor utility calculation unit 112 calculates the utility of each of the plurality of parking floors 80 using the parking floor utility function V_{f} shown in the above Expression (5) based on the parking lot condition acquired by the parking lot condition acquisition unit 106. Specifically, the parking floor utility calculation unit 112 calculates, for each of the parking floors 80, the number of remaining slots O_{f} using the parking lot condition. The parking floor utility calculation unit 112 then calculates the value of the utility function V_{O}(O_{f}) shown in the above Expression (8) (the utility regarding ease of finding an available parking space). The utility function V_{L}(L) regarding the time element shown in Expression (6) may be constant regardless of the number of remaining slots for each of the parking floors 80. Accordingly, the parking floor utility calculation unit 112 calculates the utility of each of the plurality of parking floors 80 using the parking floor utility function V_{f} shown in the above Expression (5).

The parking floor selection unit 114 selects parking floors 80 to be allocated to the plurality of respective vehicles based on the utility of each of the plurality of parking floors 80 calculated by the parking floor utility calculation unit 112. For example, the parking floor selection unit 114 may select, for the vehicle to be processed, the parking floor 80 whose utility is the largest at this stage. Alternatively, the parking floor selection unit 114 may select, for the vehicle to be processed, the parking floor 80 probabilistically in such a way that parking floors 80 with larger utilities have a higher probability of being selected (selection percentage) at this stage. The parking floor selection unit 114 may select the parking floor 80 by, for example, roulette wheel selection.

The parking floor selection unit 114 may select the parking floor 80 in accordance with, for example, the selection percentage Pf expressed by the following Expression (9). In Expression (9), M denotes the total number of parking floors 80. The symbol n denotes the number of the parking floor 80 in the level that is the closest to the slope entrance/exit 72 (the smallest parking floor number). By selecting the parking floor 80 in accordance with the selection percentage P_{f} shown in Expression (9), the probability that a parking floor 80 with a great utility is selected may become high.

$$\begin{matrix}[ Expression 7 ] & \\ {P}_{f} = \frac{{V}_{f}}{{\sum }_{m = n}^{M} {V}_{m}} & ( 9 )\end{matrix}$$

The parking block processing unit 120 performs, for each of the vehicles, processing for allocating the parking block 60 where the vehicle should be parked on the parking floor 80 selected by the parking floor selection unit 114. Assume here that a parking lot which is being designed will be operated in the future. In this case, the parking block processing unit 120 predicts the parking blocks 60 selected by the respective vehicles (drivers of the respective vehicles). That is, the parking block processing unit 120 allocates the parking blocks 60 where it is predicted that the respective vehicles will be parked to the respective vehicles. In other words, the parking block processing unit 120 selects the parking blocks 60 where it is predicted that the respective vehicles will be parked.

The parking block utility calculation unit 122 corresponds to the parking block utility calculation unit 30 shown in FIG. 1. The parking block utility calculation unit 122 calculates the utility of each of the plurality of parking blocks 60 in the parking floor 80 selected by the parking floor selection unit 114 based on the parking lot condition acquired by the parking lot condition acquisition unit 106. The parking block utility calculation unit 122 calculates the utility of each of the plurality of parking blocks 60 in the parking floor 80 selected by the parking floor selection unit 114 using the parking block utility function V₃ shown in Expression (1). Since the specific processing of the parking block utility calculation unit 122 is substantially similar to the processing of the parking block utility calculation unit 30, the description thereof will be omitted.

The parking block selection unit 124 corresponds to the parking block selection unit 40 shown in FIG. 1. The parking block selection unit 124 selects the parking blocks 60 to be allocated to the plurality of respective vehicles based on the utility of each of the plurality of parking blocks 60 calculated by the parking block utility calculation unit 122. Accordingly, the parking block selection unit 124 selects, for each of the vehicles, a parking block 60 in the parking floor 80 selected by the parking floor selection unit 114. Since the specific processing of the parking block selection unit 124 is substantially similar to the processing of the parking block selection unit 40, the description thereof will be omitted.

The selection result storing unit 130 stores results of selecting parking places (the parking floors 80 and the parking blocks 60) for the respective vehicles. The selection result storing unit 130 may be implemented by the storage unit 14. The selection result storing unit 130 stores, for each of the vehicles, results of selecting parking places every time the selection processing by the parking floor selection unit 114 and the parking block selection unit 124 is executed.

After the selection processing is ended, the allocation list generation unit 140 generates a list of parking places (the parking floors 80 and the parking blocks 60) allocated to the respective vehicles whose number corresponds to the parking demand. The allocation list indicates, for example, identification information on the parking floors 80 and the parking blocks 60 that have been allocated to vehicles entering a virtual parking lot 70 in order from a vehicle that enters the parking lot first in a simulation. For example, the allocation list includes information such as “vehicle number #1, parking floor number #3, parking block number #1”, “vehicle number #2, parking floor number #4, parking block number #2”, for the number of vehicles that correspond to the parking demand. “Vehicle number #1, parking floor number #3, parking block number #1” indicates that the parking block 60 of the “parking block number #1” in the parking floor 80 of the “parking floor number #3” has been allocated (selected) to the vehicle of the “vehicle number #1” (the first vehicle). Likewise, “vehicle number #2, parking floor number #4, parking block number #2” indicates that the parking block 60 of the “parking block number #2” in the parking floor 80 of the “parking floor number #4” has been allocated (selected) to the vehicle of the “vehicle number #2” (the second vehicle).

The simulation processing unit 150 performs processing so as to move virtual vehicles in the virtual parking lot 70 in a simulation. The simulation processing unit 150 performs processing so as to move the respective vehicles by a simulation to the parking floors 80 and the parking blocks 60 that have been selected, which correspond to moving destinations. Specifically, the simulation processing unit 150 performs processing so as to move the respective vehicles whose number correspond to the parking demand to the allocated parking places (the parking floors 80 and the parking blocks 60) in the virtual parking lot 70. That is, the simulation processing unit 150 performs processing so as to move the respective vehicles whose number correspond to the parking demand to the parking places (the parking floors 80 and the parking blocks 60) shown in the allocation list in the simulation. The simulation processing unit 150 may perform the simulation by a multi-agent simulator system.

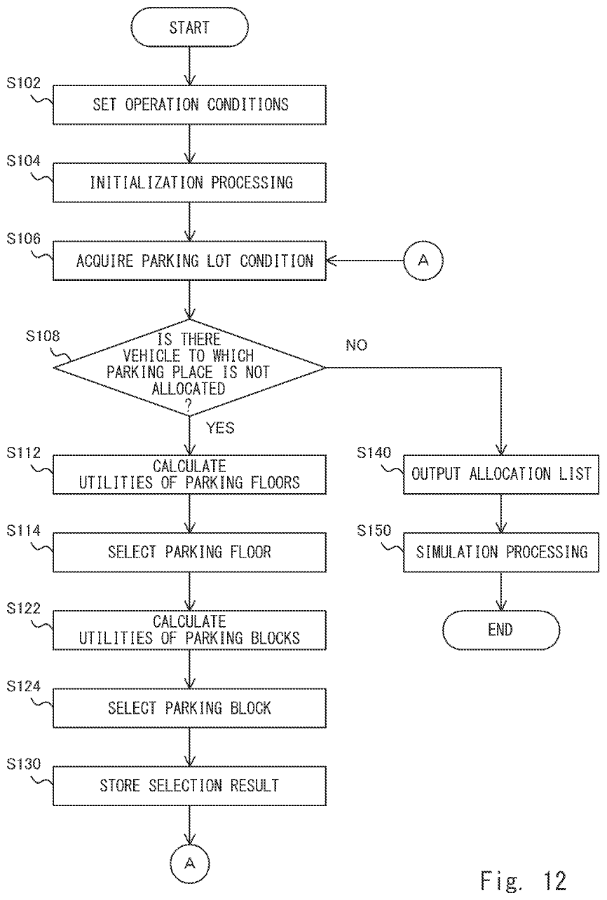

FIG. 12 is a flowchart showing processing by the simulation unit 100 according to the second embodiment. FIG. 12 corresponds to one example of the parking lot management method performed by the parking lot management system 1. As described above, the operation condition setting unit 102 sets the operation conditions of the parking lot 70 to be managed (Step S102). As described above, the initialization processing unit 104 performs initialization processing (Step S104). As described above, the parking lot condition acquisition unit 106 acquires the parking lot condition in the parking lot 70 (Step S106).

The simulation unit 100 determines whether or not there is a vehicle, of the vehicles that correspond to the parking demand, to which a parking place is not allocated (Step S108). When there is a vehicle to which a parking place is not allocated (YES in S108), the processing of the parking floor processing unit 110 (S112 and S114) and the processing of the parking block processing unit 120 (S122 and S124) are executed. As described above, the parking floor utility calculation unit 112 calculates the utility of each of the plurality of parking floors 80 using the parking floor utility function based on the parking lot condition acquired in the processing of S106 (Step S112). As described above, the parking floor selection unit 114 selects the parking floor 80 to be allocated to the vehicle to be processed based on the utility of each of the plurality of parking floors 80 calculated in the processing of S112 (Step S114).

As described above, the parking block utility calculation unit 122 calculates the utility of each of the plurality of parking blocks 60 in the parking floor 80 selected in the processing of S114 based on the parking lot condition acquired in the processing of S106 (Step S122). The parking block selection unit 124 selects the parking block 60 to be allocated to the vehicle to be processed based on the utility of each of the plurality of parking blocks 60 calculated in the processing of S122 (Step S124).

As described above, the selection result storing unit 130 stores, for each of the vehicles, the selection result indicating the parking place (the parking floor 80 and the parking block 60) selected in the processing of S114 and S124 (Step S130). Then the process flow returns to S106. As described above, the parking lot condition acquisition unit 106 is able to acquire the parking lot condition from the selection result stored in the selection result storing unit 130 (S106).

On the other hand, when there is no vehicle to which a parking place is not allocated (NO in S108), as described above, the allocation list generation unit 140 generates an allocation list and outputs the generated allocation list (Step S140). As described above, the simulation processing unit 150 performs processing in the simulation so as to move the plurality of respective vehicles to the parking places shown in the allocation list (the parking floors 80 and the parking blocks 60) (Step S150).

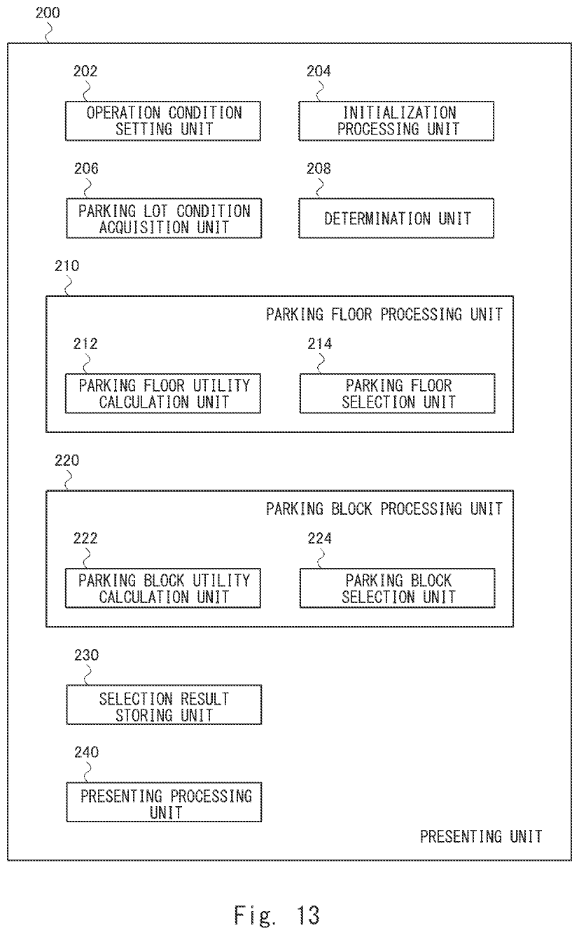

FIG. 13 is a diagram showing a configuration of the presenting unit 200 according to the second embodiment. The presenting unit 200 includes an operation condition setting unit 202, an initialization processing unit 204, a parking lot condition acquisition unit 206, a determination unit 208, a parking floor processing unit 210, a parking block processing unit 220, a selection result storing unit 230, and a presenting processing unit 240. The parking floor processing unit 210 includes a parking floor utility calculation unit 212 and a parking floor selection unit 214. The parking block processing unit 220 includes a parking block utility calculation unit 222 and a parking block selection unit 224.

The operation condition setting unit 202 sets the operation conditions when parking places are presented (recommended) for vehicles. The operation condition setting unit 202 may set the operation conditions by receiving, for example, input information obtained by the operator operating the interface unit 18. Alternatively, the operation condition setting unit 202 may set the operation conditions by reading the operation conditions stored in advance. Alternatively, the operation condition setting unit 202 may set the operation conditions from the current date (day of the week, a specific day or the like), time, and weather. For example, the operation condition setting unit 202 may set operation conditions like “type of the parking lot: a six-story flat parking lot attached to a shopping mall, time zone: morning, season: winter, weather: fine”. Alternatively, the operation condition setting unit 202 may set operation conditions like “type of the parking lot: a three-story flat parking lot for employees, time zone: time when employees come to work, season: spring, weather: rain”.

The initialization processing unit 204 performs initialization processing of various kinds of setting when parking places are presented (recommended). That is, the initialization processing unit 204 sets various kinds of parameters used when the parking floors 80 and the parking blocks 60 are selected. The initialization processing unit 204 may perform initialization processing by receiving, for example, input information obtained by the operator operating the interface unit 18. Alternatively, the initialization processing unit 204 may perform initialization processing by reading parameters stored in advance. The initialization processing may include, for example, parking lot object initialization, agent object initialization, and utility calculation object initialization.

In the parking lot object initialization, the initialization processing unit 204 sets structural data of the parking lot 70 to be managed that corresponds to the type of the parking lot set in the operation conditions. Further, the initialization processing unit 204 sets the travelling distance and the walking distance regarding each of the parking blocks 60 of the parking lot 70. Further, the initialization processing unit 204 may set the travelling distance from the slope entrance/exit 72 to each of the parking floors 80, the moving distance in the raising and lowering equipment from each of the parking floors 80 to the target floor, and the walking distance from the raising and lowering equipment to the destination G.

In the agent object initialization, the initialization processing unit 204 sets the travelling speed of the vehicle and the walking speed of the pedestrian. Further, the initialization processing unit 204 may set the raising and lowering speed of a pedestrian in the raising and lowering equipment, which is stairs.

In the utility calculation object initialization, the initialization processing unit 204 sets parameters of the parking block utility function adapted to the set operation conditions. Further, the initialization processing unit 204 calculates, for each of the parking blocks 60, the time element L shown in Expression (3), and the utility function V_{L}(L) regarding the time element L shown in Expressions (1) and (2) using the set parameters of the utility function. Further, the initialization processing unit 204 calculates, for each of the parking blocks 60, the initial value of the utility function V_{P}(J) representing the utility in accordance with ease of parking shown in Expression (1).

Further, in the utility calculation object initialization, the initialization processing unit 204 sets the parameters of the parking floor utility function adapted to the set operation conditions. Further, the initialization processing unit 204 calculates, for each of the parking floors 80, the time element L shown in Expression (7), and the utility function V_{L}(L) regarding the time element L shown in Expressions (5) and (6) using the set parameters of the utility function. Further, the initialization processing unit 204 calculates, for each of the parking blocks 60, the initial value of the utility function V_{O}(O_{f}) regarding ease of finding an available parking space shown in Expressions (5) and (8).

The parking lot condition acquisition unit 206 corresponds to the parking lot condition acquisition unit 20 shown in FIG. 1. The parking lot condition acquisition unit 206 acquires the parking lot condition in the parking lot 70 that is to be managed and is being operated using a sensor or the like. Specifically, the parking lot condition acquisition unit 206 acquires information (parking lot condition information) indicating how many vehicles are parked in each of the parking floors 80 in the current parking lot 70. Further, the parking lot condition acquisition unit 206 acquires information (parking lot condition information) indicating how many vehicles are parked in each of the parking blocks 60 in the current parking lot 70.

At a timing of presenting a parking place for a vehicle that is currently entering the parking lot 70, it is possible that a vehicle that has entered before the above vehicle (a previous vehicle) has not yet been parked in a parking place presented for the previous vehicle. Therefore, like in the parking lot condition acquisition unit 106, the parking lot condition acquisition unit 206 may acquire information indicating the parking place allocated to the vehicle previously entered (the parking floor 80 and the parking block 60). The parking lot condition acquisition unit 206 may temporarily acquire information indicating the parking place allocated to the vehicle previously entered. This information may be acquired from data indicating results of selecting the parking floors 80 and the parking blocks 60 stored in the selection result storing unit 230 that will be described later. The time limitation for acquiring “the information indicating the parking place allocated to the vehicle previously entered” may be the time when it is expected that “the vehicle previously entered” may be parked in the allocated parking place. That is, at the time “the vehicle previously entered” would be parked in the parking place to which “the vehicle previously entered” is allocated, the parking lot condition regarding this parking place may not be acquired from the selection result since it may be acquired using a sensor or the like. The “time when it is expected that the vehicle previously entered may be parked” may be calculated from, for example, the travelling distance to the parking place allocated to this vehicle and a predetermined time expected to be required for the parking operation.

The determination unit 208 determines whether or not to present (recommend) the parking place. Specifically, the determination unit 208 determines that a parking place will be presented when there is a vehicle entering the parking lot 70 and a condition that requires presentation of a parking place is satisfied. Further specifically, the determination unit 208 determines whether or not there is a vehicle entering the parking lot 70. When there is no vehicle entering the parking lot 70, the determination unit 208 determines that a parking place will not be presented. The determination regarding whether or not there is a vehicle entering the parking lot 70 can be performed using, for example, a sensor or the like provided near the slope entrance/exit 72 (e.g., near the entrance gate).

The determination unit 208 further determines whether or not a condition that requires presentation of a parking place will be satisfied. This condition may be set as appropriate by an operator or the like of the parking lot 70. For example, if the number of vehicles entering the parking lot 70 increases in a specific time zone (around the beginning of working hours), like in an employee parking lot or the like, it may be determined that parking places will always be presented in a certain time zone in order to prevent roads near the parking lot 70 from being affected by the entrance of the vehicles. Alternatively, an area inside the parking lot 70 may be monitored using a sensor or the like, and parking places may be presented when there are more vehicles stacking up in a passage in the parking lot 70. Note that the determination regarding whether or not there are more vehicles stacking up in a passage may be made, for example, by detecting the number of vehicles that are stacking up in the passage. When the number of vehicles stacking up in the passage exceeds a predetermined number, it may be determined that there are more vehicles stacking up in the passage, and thus parking places may be presented.

The parking floor processing unit 210 performs, for each of the vehicles, processing for allocating the parking floor 80 where the vehicle should be parked. The parking floor utility calculation unit 212 calculates the utility of each of the plurality of parking floors 80 based on the parking lot condition acquired by the parking lot condition acquisition unit 206 using the parking floor utility function V_{f} shown in the above Expression (5). Since the processing of the parking floor utility calculation unit 212 is substantially similar to the processing of the aforementioned parking floor utility calculation unit 112, the description thereof will be omitted. Unlike the processing of the parking floor utility calculation unit 112, in the processing of the parking floor utility calculation unit 212, the parking lot condition for calculating the utility of each of the parking floors 80 corresponds to the condition in the current actual parking lot 70, as described above.

The parking floor selection unit 214 selects the parking floors 80 allocated to the plurality of respective vehicles based on the utility of each of the plurality of parking floors 80 calculated by the parking floor utility calculation unit 212. For example, the parking floor selection unit 214 may select, for the vehicle to be processed, the parking floor 80 whose utility is the largest at this stage, like in the processing of the parking floor selection unit 114. Alternatively, the parking floor selection unit 214 may select, for the vehicle to be processed, the parking floor 80 probabilistically in such a way that parking floors 80 with larger utilities have a higher probability of being selected (selection percentage) at this stage, like in the processing of the parking floor selection unit 114.

Alternatively, the parking floor selection unit 214 may select the parking floor 80 in such a way that stacking of vehicles inside the parking lot 70 is reduced. That is, the parking floor selection unit 214 may select the parking floor 80 in such a way that a situation in which vehicles to be processed are stacked due to the parking operation by the vehicle that has entered before the vehicle to be processed is reduced. Specifically, the parking floor selection unit 214 may select, of parking floors 80 with larger utility, a parking floor 80 other than the parking floor 80 allocated to the vehicle (previous vehicle) that has entered just before the vehicle to be processed.

Assume, as one example, that the parking floor 80-3 of “parking floor number #3” has been allocated to the previous vehicle and that the utility of “parking floor number #3” is the largest, followed by the utility of “parking floor number #4”, and then the utility of “parking floor number #2” in this order at the timing when the vehicle to be processed is processed. In this case, the parking floor selection unit 214 may select the parking floor 80-4 of “parking floor number #4”, not the parking floor of “parking floor number #3”, for the vehicle to be processed. Accordingly, the vehicle to be processed is able to travel to the parking floor 80-4 allocated to itself without being stacked due to the presence of the previous vehicle that is being parked on the parking floor 80-3.

The parking block processing unit 220 performs processing for allocating, for each of the vehicles, the parking block 60 in the parking floor 80 selected by the parking floor selection unit 214 where a vehicle should be parked. The parking block utility calculation unit 222 corresponds to the parking block utility calculation unit 30 shown in FIG. 1. The parking block utility calculation unit 222 calculates the utility of each of the plurality of parking blocks 60 on the parking floor 80 selected by the parking floor selection unit 214 based on the parking lot condition acquired by the parking lot condition acquisition unit 206. The parking block utility calculation unit 222 calculates the utility of each of the plurality of parking blocks 60 on the parking floor 80 selected by the parking floor selection unit 214 using the parking block utility function V₃ shown in Expression (1). Since the specific processing of the parking block utility calculation unit 222 is substantially similar to the processing of the parking block utility calculation unit 30, the description thereof will be omitted. Note that, unlike the processing of the parking block utility calculation unit 122, in the processing of the parking block utility calculation unit 222, the parking lot condition for calculating the utility of each of the parking blocks 60 corresponds to the state in the current actual parking lot 70, as described above.

The parking block selection unit 224 corresponds to the parking block selection unit 40 shown in FIG. 1. The parking block selection unit 224 selects parking blocks 60 to be allocated to the plurality of respective vehicles based on the utility of each of the plurality of parking blocks 60 calculated by the parking block utility calculation unit 222. Accordingly, the parking block selection unit 224 selects, for each of the vehicles, the parking block 60 in the parking floor 80 selected by the parking floor selection unit 214. Specific processing of the parking block selection unit 224 may be substantially similar to the processing of the parking block selection unit 40.

Alternatively, the parking block selection unit 224 may select the parking block 60 in such a way that stacking of vehicles inside the parking lot 70 is reduced. That is, the parking block selection unit 224 may select the parking block 60 in such a way that a situation in which vehicles to be processed are stacked due to the parking operation by the vehicle that has entered before the vehicle to be processed is reduced. Specifically, the parking block selection unit 224 selects, of the parking blocks 60 having larger utility values, a parking block 60 other than the parking block 60 allocated to the vehicle (previous vehicle) that has entered just before the vehicle to be processed. At this time, the parking block selection unit 224 may select, of the parking blocks 60 having larger utility values, a parking block 60 that is far from the parking block 60 allocated to the previous vehicle.

The parking block selection unit 224 may select, for example, one of the parking blocks 60 having larger utility values that is spaced apart from the parking block 60 allocated to the previous vehicle by a predetermined distance or larger. Alternatively, the parking block selection unit 224 may select one of the parking blocks 60 having larger utility values that is spaced apart from the parking block 60 allocated to the previous vehicle by a predetermined number of parking blocks 60 or more.

Assume, as one example, that the same parking floor 80 has been allocated to a vehicle to be processed and the previous vehicle. It is further assumed that the parking block 60 of “parking block number #33” has been allocated to the previous vehicle in the example shown in FIG. 2. Then, it is assumed that the utility of the “parking block number #33” is the largest, followed by the utility of the “parking block number #32”, the utility of the “parking block number #31”, the utility of the “parking block number #30”, the utility of the “parking block number #29”, and the utility of the “parking block number #28” in this order at the timing when the vehicle to be processed is processed. In this case, the “parking block number #33” allocated to the previous vehicle and the “parking block number #32”, the “parking block number #31”, and the “parking block number #30” that are close to the “parking block number #33” may be excluded from the parking blocks 60 to be selected. Then, the parking block selection unit 224 may select the parking block 60 of the “parking block number #29” for the vehicle to be processed.

The selection result storing unit 230 stores the results of selecting the parking places (the parking floors 80 and the parking blocks 60) for the respective vehicles. The selection result storing unit 230 may be implemented by the storage unit 14. The selection result storing unit 230 stores, for each of the vehicles, results of selecting parking places every time the selection processing by the parking floor selection unit 214 and the parking block selection unit 224 is executed. Note that the selection result storing unit 230 does not need to permanently store selection results for the respective vehicles. When it is time for users to park their vehicles in the parking places that have been allocated to the respective vehicles, the selection results may be erased. That is, at the time the users would have parked their vehicles in the parking places that have been allocated to the respective vehicles, the parking lot conditions regarding these parking places may not be stored as the selection results any longer since they may be acquired using a sensor or the like.

The presenting processing unit 240 performs processing for presenting the selected parking place (the parking floor 80 and the parking block 60) for a vehicle to be processed. Specifically, the presenting processing unit 240 performs processing for outputting information indicating the selected parking place for the vehicle to be processed (vehicle entering the parking lot 70). For example, the presenting processing unit 240 may control an output device (such as a display or a speaker) which is located near the slope entrance/exit 72 to cause this output device to output information indicating the selected parking place by, for example, an image or a voice. Alternatively, the presenting processing unit 240 may control an output device (such as a display or a speaker) mounted on the vehicle to be processed to cause this output device to output information indicating the selected parking place to be output by, for example, an image or a voice. Alternatively, when the vehicle to be processed is a self-driving car, the presenting processing unit 240 may output the information indicating the selected parking place to a self-driving system of a vehicle as an instruction for instructing a moving destination.

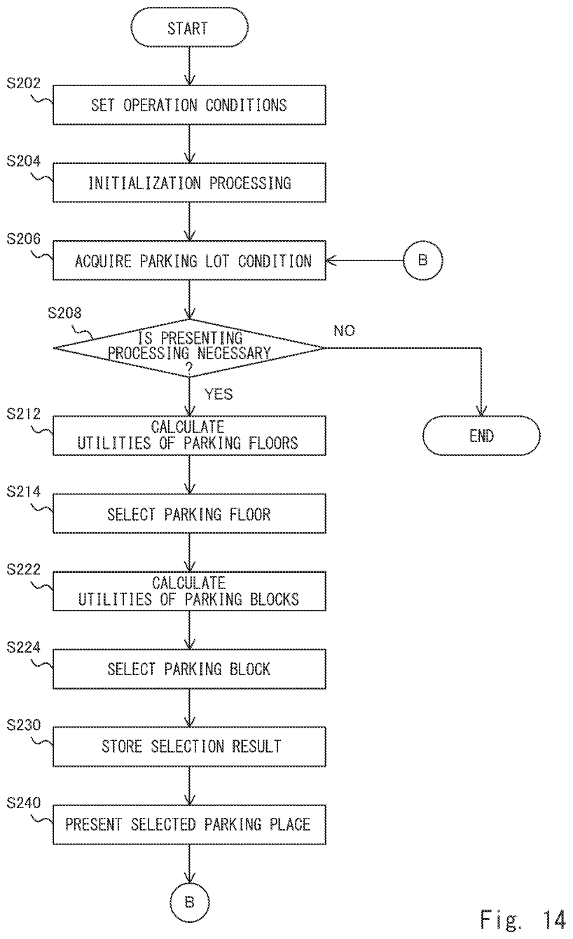

FIG. 14 is a flowchart showing processing performed by the presenting unit 200 according to the second embodiment. FIG. 14 corresponds to one example of the parking lot management method performed by the parking lot management system 1. As described above, the operation condition setting unit 202 sets the operation conditions of the parking lot 70 to be managed (Step S202). As described above, the initialization processing unit 204 performs initialization processing (Step S204). As described above, the parking lot condition acquisition unit 206 acquires the parking lot condition in the parking lot 70 (Step S206).

As described above, the determination unit 208 determines whether or not processing of presenting a parking place is necessary (Step S208). When it has been determined that the presenting processing is not necessary (NO in S208), the processing is ended. Alternatively, in this case, the process flow may return to the processing of S206. On the other hand, when it has been determined that the presenting processing is necessary (YES in S208), the processing of the parking floor processing unit 210 (S212 and S214) and the processing of the parking block processing unit 220 (S222 and S224) are executed. As described above, the parking floor utility calculation unit 212 calculates the utility of each of the plurality of parking floors 80 using the parking floor utility function based on the parking lot condition acquired in the processing of S206 (Step S212). As described above, the parking floor selection unit 214 selects the parking floor 80 to be allocated to the vehicle to be processed based on the utility of each of the plurality of parking floors 80 calculated in the processing of S212 (Step S214).

As described above, the parking block utility calculation unit 222 calculates the utility of each of the plurality of parking blocks 60 in the parking floor 80 selected in the processing of S214 based on the parking lot condition acquired in the processing of S206 (Step S222). The parking block selection unit 224 selects the parking block 60 to be allocated to the vehicle to be processed based on the utility of each of the plurality of parking blocks 60 calculated in the processing of S222 (Step S224).

As described above, the selection result storing unit 230 stores, for each of the vehicles, the selection results indicating the parking place (the parking floor 80 and the parking block 60) selected in the processing of S214 and S224 (Step S230). As described above, the presenting processing unit 240 presents the parking place (the parking floor 80 and the parking block 60) selected in the processing of S214 and S224 for the vehicle entering the parking lot 70 (Step S240).

As described above, the parking lot management system 1 according to the second embodiment manages the parking lot 70 that includes a plurality of parking floors 80, each including a plurality of parking blocks 60. Then, the parking floor utility calculation units 112 and 212 calculate the utility of each of the parking floors using a parking floor utility function, which is a utility function set in advance regarding the parking floor 80. Further, the parking floor selection units 114 and 214 select the parking floors 80 to be allocated to the plurality of respective vehicles based on the utility of the plurality of parking floors 80. Further, the parking block utility calculation units 122 and 222 calculate the utility of each of the parking blocks 60 in the selected parking floor 80. Then the parking block selection units 124 and 224 select the parking block 60 in the selected parking floor 80.

According to the aforementioned configuration of the parking lot management system 1 according to the second embodiment, it is possible to efficiently manage a multistory parking lot (a flat multistory parking lot) including a plurality of parking floors separated from each other. That is, since a multistory parking lot normally includes a large number of parking spaces, the number of parking blocks may be enormous as well. Then, processing of calculating the utility for each of all the huge number of parking blocks and selecting a parking block may be complicated processing. On the other hand, in the multistory parking lot, the utility may vary not only for the parking blocks in each parking floor, but also for the parking floors. Therefore, by separating the processing for the parking floors from the processing for the parking blocks, like in the second embodiment, calculation of utility may be simplified. Therefore, it becomes possible to efficiently perform processing of allocating the parking places.

Further, the simulation unit 100 of the parking lot management system 1 according to the second embodiment is configured to manage a virtual parking lot. Then, the simulation processing unit 150 performs processing so as to cause the vehicle to move by a simulation to the selected parking block, which is a moving destination. With the configuration of the parking lot management system 1 according to the second embodiment, it becomes possible to simulate the operation of the vehicle in the parking lot at a high speed. That is, the parking block, which is the moving destination, may be selected in advance instead of selecting it in the middle of the operation in which the vehicle is moving in the parking lot in the simulation, whereby it is possible to reduce the computation load. Therefore, it is possible to perform the simulation at a high speed.

Further, the presenting unit 200 of the parking lot management system 1 according to the second embodiment is configured to manage an actual parking lot. Then, the presenting processing unit 240 performs processing for presenting information where the selected parking block is set as the moving destination for a vehicle entering the parking lot. With the configuration of the parking lot management system 1 according to the second embodiment, by presenting parking blocks that are easily accepted by actual users, it is possible to reduce stacking of vehicles in a parking lot. That is, by presenting parking blocks having a relatively large utility, it becomes easy for the user to accept that he/she will move his/her vehicle to the presented parking block. For example, if the difference between the utility of the parking block where the driver originally wanted to park his/her vehicle and the utility of the presented parking block is small, it is highly likely that the driver can accept the presented parking block. Therefore, it is possible to reduce occurrence of stacking of vehicles. Alternatively, by presenting the parking block (parking place) while vehicles are stacking in the parking lot, it becomes easy to reduce stacking of vehicles.

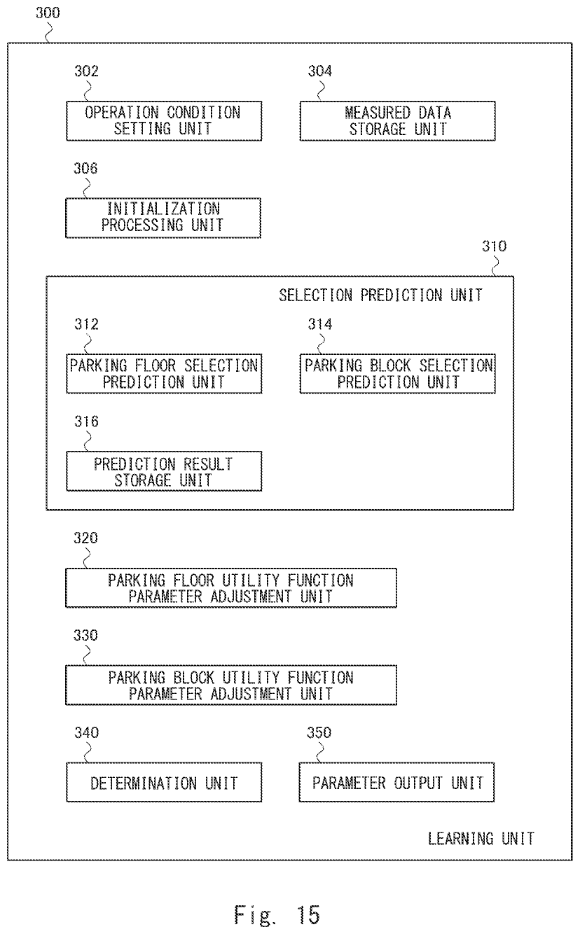

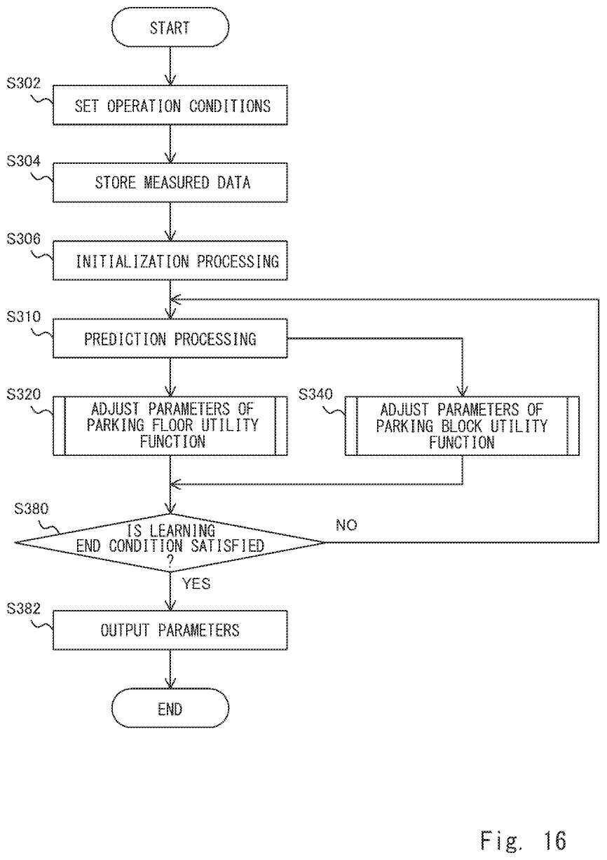

FIG. 15 is a diagram showing a configuration of the learning unit 300 according to the second embodiment. Further, FIGS. 16-19 are flowcharts showing processing by the learning unit 300 according to the second embodiment. FIGS. 16 to 19 correspond to the learning method for learning parameters of the utility function. The learning unit 300 includes an operation condition setting unit 302, a measured data storage unit 304, an initialization processing unit 306, a selection prediction unit 310, a parking floor utility function parameter adjustment unit 320, a parking block utility function parameter adjustment unit 330, a determination unit 340, and a parameter output unit 350. The selection prediction unit 310 includes a parking floor selection prediction unit 312, a parking block selection prediction unit 314, and a prediction result storage unit 316. In the following, with reference to the flowchart, processing of each of the components will be described. Note that the processing in the following flowcharts is merely one example.

The operation condition setting unit 302 sets operation conditions to which parameters of the utility function (utility function parameters) should be adapted in learning (Step S302). The operation condition setting unit 302 may set the operation conditions by receiving, for example, input information obtained by the operator operating the interface unit 18. Alternatively, the operation condition setting unit 302 may set the operation conditions by reading the operation conditions stored in advance. For example, the operation condition setting unit 302 may set operation conditions like “type of the parking lot: a six-story flat parking lot attached to a shopping mall, time zone: morning, season: winter, weather: fine”. In this case, utility function parameters which are to be learned may be adapted in accordance with the operation conditions like “type of the parking lot: a six-story flat parking lot attached to a shopping mall, time zone: morning, season: winter, weather: fine”. Alternatively, the operation condition setting unit 302 may set operation conditions like “type of the parking lot: a three-story flat parking lot for employees, time zone: time when employees come to work, season: spring, weather: rain”. In this case, utility function parameters which are to be learned may be adapted in accordance with the operation conditions like “type of the parking lot: a three-story flat parking lot for employees, time zone: time when employees come to work, season: spring, weather: rain”. In the following description, it is assumed that the utility function parameters regarding the flat multistory parking lot are adjusted.

The measured data storage unit 304 stores measured data to be used for learning (Step S304). The measured data may include the number of vehicles that are parked in each of the parking places (the parking floors 80 and the parking blocks 60) in each time zone in the actual parking lot. Note that, before the parking lot starts to be operated, measured data in this parking lot cannot be obtained. However, the measured data may not be data obtained in the parking lot to which the utility function parameters are to be adapted. In this case, the measured data is data obtained as a result of operating the actual parking lot under conditions that are close to the set operation conditions as much as possible. Further, the measured data is data obtained as a result of operating a parking lot having a structure that is close to the structure of the parking lot to which the utility function parameters are to be adapted.

The initialization processing unit 306 performs initialization processing (Step S306). For example, the initialization processing unit 306 may perform initialization processing by receiving input information obtained by the operator operating the interface unit 18. Alternatively, the initialization processing unit 306 may perform initialization processing by reading parameters stored in advance. The initialization processing unit 306 sets a threshold for evaluating the difference (error) between a prediction result that will be described later and the measured result (measured data). Further, when prediction processing (S310 that will be described later) is performed from a state in which some vehicles have already been parked in a parking lot, the initialization processing unit 306 sets the number of vehicles that are parked in the parking floors 80 and the parking blocks 60 at the time of start of prediction.

Further, the initialization processing may include, for example, parking lot object initialization, agent object initialization, and utility calculation object initialization. Since the parking lot object initialization and the agent object initialization are substantially similar to the processing of the initialization processing unit 104 in the simulation unit 100, the description thereof will be omitted.

In the utility calculation object initialization, the initialization processing unit 306 sets the initial values of the utility function parameters. Note that in some embodiments, γ, β, c, w, and dᵢ are set to sufficiently small values. Further, the initialization processing unit 306 calculates, for each of the parking blocks 60, the time element L shown in Expression (3), and the utility function V_{L}(L) regarding the time element L shown in Expressions (1) and (2) using the set parameters of the utility function. Further, the initialization processing unit 306 calculates, for each of the parking blocks 60, the initial value of the utility function V_{P}(J) representing the utility in accordance with ease of parking shown in Expression (1). Further, the initialization processing unit 306 calculates, for each of the parking floors 80, the time element L shown in Expression (7), and the utility function V_{L}(L) regarding the time element L shown in Expressions (5) and (6) using the set parameters of the utility function. Further, the initialization processing unit 306 calculates, for each of the parking blocks 60, the initial value of the utility function V_{O}(O_{f}) regarding ease of finding an available parking space shown in Expressions (5) and (8).

The selection prediction unit 310 performs processing of predicting selection of the parking place (Step S310). Specifically, the parking floor selection prediction unit 312 performs processing that is substantially similar to the processing of the aforementioned parking floor processing unit 110 (S112 and S114) for each of the virtual vehicles whose number corresponds to the number of vehicles that are being parked in the measured data. Further, the parking block selection prediction unit 314 performs processing that is substantially similar to the aforementioned processing of the parking block processing unit 120 (S122 and S124) for each of the virtual vehicles whose number corresponds to the number of vehicles that are being parked in the measured data. Further, the prediction result storage unit 316 stores the prediction result of the selection of the parking place (the parking floor 80 and the parking block 60) for each of the vehicles. The prediction result storage unit 316 may generate the allocation list of parking places (the parking floors 80 and the parking blocks 60) allocated to the plurality of respective vehicles as the prediction result and store the generated allocation list.

The parking floor utility function parameter adjustment unit 320 adjusts parameters of the parking floor utility function (Step S320). Note that the parking floor utility function parameter adjustment unit 320 may not adjust all the parameters of the parking floor utility function and may instead adjust some of these parameters. The parking floor utility function parameter adjustment unit 320 adjusts the parameters in such a way that the difference between the result of prediction of the selection of the parking floor and the selection of the parking floor of the vehicle in the actual measurement decreases. The details thereof will be described later.

Further, the parking block utility function parameter adjustment unit 330 adjusts the parameters of the parking block utility function (Step S340). Note that the parking block utility function parameter adjustment unit 330 may not adjust all the parameters of the parking block utility function and may instead adjust some of the parameters. The parking block utility function parameter adjustment unit 330 adjusts the parameters in such a way that the difference between the result of prediction of the selection of the parking block and the selection of the parking block of the vehicle in the actual measurement decreases. The details thereof will be described later.

The determination unit 340 determines whether or not the learning end condition is satisfied (Step S380). Specifically, the determination unit 340 determines that the learning processing is ended when the difference between the prediction result obtained by the prediction processing and the measured result has become equal to or smaller than a predetermined threshold or when the iteration number of times of the prediction processing has reached a predetermined upper limit. The details thereof will be described later.

When it has been determined that the learning end condition is not satisfied (NO in S380), the process flow returns to the processing of S310, where the prediction processing is performed and the adjustment of the utility function parameters is performed (S310, S320, and S340). In the prediction processing performed again, parameters adjusted in the previous processing of adjusting the parameters (S320 and S340) are used. On the other hand, when it has been determined that the learning end condition is satisfied (YES in S380), the parameter output unit 350 outputs the adjusted utility function parameters (Step S382). Accordingly, the adjustment of the utility function parameters is ended. Then the utility function parameters are adapted in accordance with the operation conditions set at the time of learning.

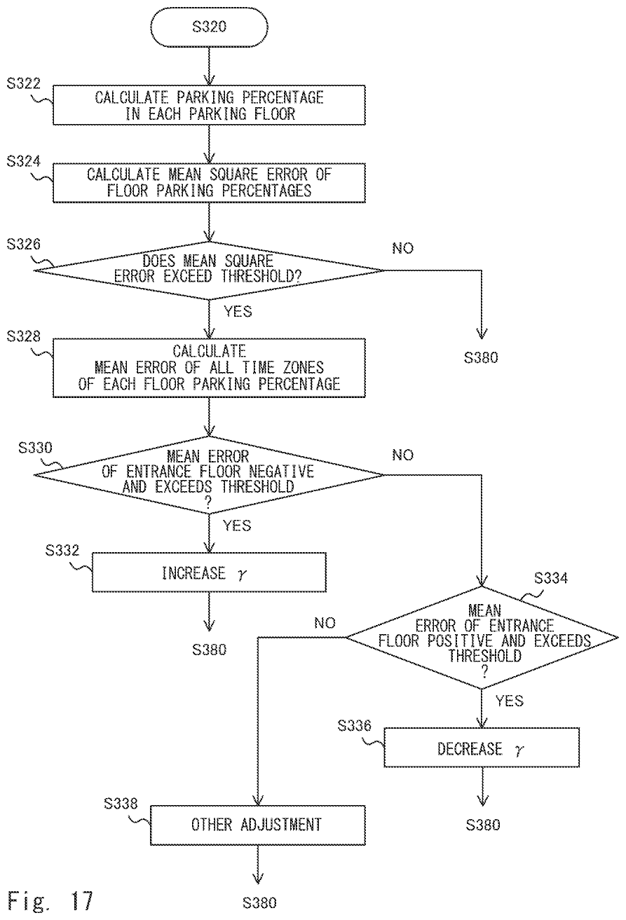

FIG. 17 is a flowchart showing processing of S320. The parking floor utility function parameter adjustment unit 320 calculates the parking percentage (floor parking percentage) in each parking floor 80 in each time zone for the prediction result and the measured result (Step S322). The “parking percentage” in one parking place (a parking floor 80 or a parking block 60) here means the percentage of the number of vehicles that are parked in the parking place at this stage with respect to the number of vehicles that can be parked in the parking place (the total number of parking spaces). That is, (parking percentage)=(the number of vehicles parked at present)/(the total number of parking spaces). When, for example, the number of vehicles that can be parked in one parking floor 80 is 100 and the number of vehicles that are parked in the parking floor 80 at this stage is 50, the parking percentage of the parking floor 80 at this stage is 50%. When, for example, the measured data is the one from 7:00 to 9:00, the parking floor utility function parameter adjustment unit 320 may calculate, for the measured data, the parking percentage (measured parking percentage) of each of the parking floors 80 for example, every 15 minutes. Likewise, the parking floor utility function parameter adjustment unit 320 may calculate, for the prediction result, the parking percentage (predicted parking percentage) of each of the parking floors 80 for example, every 15 minutes. In this case, the length of the time zone where the parking percentage is calculated is 15 minutes.

The parking floor utility function parameter adjustment unit 320 calculates the mean square error of the calculated floor parking percentages (Step S324). Specifically, the parking floor utility function parameter adjustment unit 320 calculates the mean square error of the floor parking percentage calculated for the prediction result and the floor parking percentage calculated for the measured result. That is, the parking floor utility function parameter adjustment unit 320 calculates the mean square error between the predicted parking percentage and the measured parking percentage calculated for each time zone and each parking floor. Further specifically, for each of the prediction result and the measured result, the floor parking percentage is calculated for the number of the product of the number of time zones and the number of parking floors 80. Therefore, the parking floor utility function parameter adjustment unit 320 calculates the mean square error by adding the square value of the difference between the predicted parking percentage and the measured parking percentage calculated for each time zone and each parking floor for the number of pieces of data of the floor parking percentage and then dividing the resulting value by the number of pieces of data of the floor parking percentage. The same holds true for the mean square error of the block parking percentages that will be described later.

The parking floor utility function parameter adjustment unit 320 determines whether or not the mean square error exceeds a predetermined threshold (Step S326). When the mean square error does not exceed the threshold (NO in S326), the process flow proceeds to S380 (FIG. 16). On the other hand, when the mean square error exceeds the threshold (YES in S326), the parking floor utility function parameter adjustment unit 320 calculates the mean error of all the time zones for each of the parking floors 80 (Step S328). Specifically, the parking floor utility function parameter adjustment unit 320 calculates, for each of the parking floors 80, the average value of the error of the parking percentage in each time zone (=predicted parking percentage−measured parking percentage). When the mean error of one parking floor 80 is negative, the predicted parking percentage of the parking floor 80 is smaller than the measured parking percentage. On the other hand, when the mean error of one parking floor 80 is positive, the predicted parking percentage of the parking floor 80 is larger than the measured parking percentage.

Now, a parking floor 80 that is close to the slope entrance/exit 72 tends to be selected as a parking place where vehicles are parked since occupants can park their vehicles soon after they enter the parking lot and exit from the parking lot soon after they get into their vehicles. Then, as the number of vehicles to be parked in the parking floor 80 that is close to the slope entrance/exit 72 increases, it is highly likely that stacking of vehicles will occur in the slope 74. Therefore, in this example, in the adjustment of parameters of the parking floor utility function, the parking floor 80 that is close to the slope entrance/exit 72, that is, the entrance floor, is focused on.

The parking floor utility function parameter adjustment unit 320 determines whether or not the mean error of the entrance floor is negative and exceeds a threshold (Step S330). That is, the parking floor utility function parameter adjustment unit 320 determines whether or not the mean error of the entrance floor is negative and the absolute value of the mean error exceeds the threshold. When the mean error of the entrance floor is negative and exceeds the threshold (YES in S330), it means that the predicted parking percentage of the entrance floor is significantly smaller than the measured parking percentage. Therefore, the utility function parameters need to be adjusted in such a way that the predicted parking percentage of the entrance floor is predicted to be large. Therefore, in this case, the parking floor utility function parameter adjustment unit 320 increases γ in Expression (8) (Step S332). Accordingly, it is more likely that a prediction will be made in which the entrance floor where the parking percentage tends to be relatively high be selected as the parking floor where a vehicle should be parked. Therefore, the predicted parking percentage of the entrance floor may be predicted to be large. Then the process flow proceeds to S380. The amount by which γ is changed may be a predetermined small amount. This is applicable to adjustment of the other parameters.

On the other hand, when a condition that the mean error of the entrance floor is negative and exceeds the threshold does not hold true (NO in S330), the parking floor utility function parameter adjustment unit 320 determines whether or not the mean error of the entrance floor is positive and exceeds the threshold (Step S334). That is, the parking floor utility function parameter adjustment unit 320 determines whether or not the mean error of the entrance floor is positive and the absolute value of the mean error exceeds the threshold. When the mean error of the entrance floor is positive and exceeds the threshold (YES in S334), it means that the predicted parking percentage of the entrance floor is significantly larger than the measured parking percentage. Therefore, the utility function parameters need to be adjusted in such a way that the predicted parking percentage of the entrance floor is predicted to be small. That is, it means that γ has been made too large in the previous adjustment. Therefore, the parking floor utility function parameter adjustment unit 320 decreases γ (Step S336). Then the process flow proceeds to S380. On the other hand, when a condition that the mean error of the entrance floor is positive and exceeds the threshold does not hold true (NO in S334), the error of the predicted parking percentage of the entrance floor may be within an allowable range. Therefore, the parking floor utility function parameter adjustment unit 320 performs other adjustment processing (Step S338). The parking floor utility function parameter adjustment unit 320 may adjust, for example, parameters other than γ. Alternatively, the parking floor utility function parameter adjustment unit 320 may perform processing similar to the processing of S330 to S336 for a parking floor 80 other than the entrance floor (e.g., a parking floor 80 or the like where the connection passage 76 is provided). Then the process flow proceeds to S380.

In the processing of S320, c and w in the parking floor utility function are not learned. However, as described above, it can be considered that the weight with respect to the travelling time of the vehicle and the weight with respect to the walking time in the case in which a parking floor is selected is substantially the same as those in the case in which a parking block is selected. Therefore, in the example of the learning processing, c and w are learned in the processing of S340 and c and w learned in the processing of S340 are applied in the parking floor utility function as well.

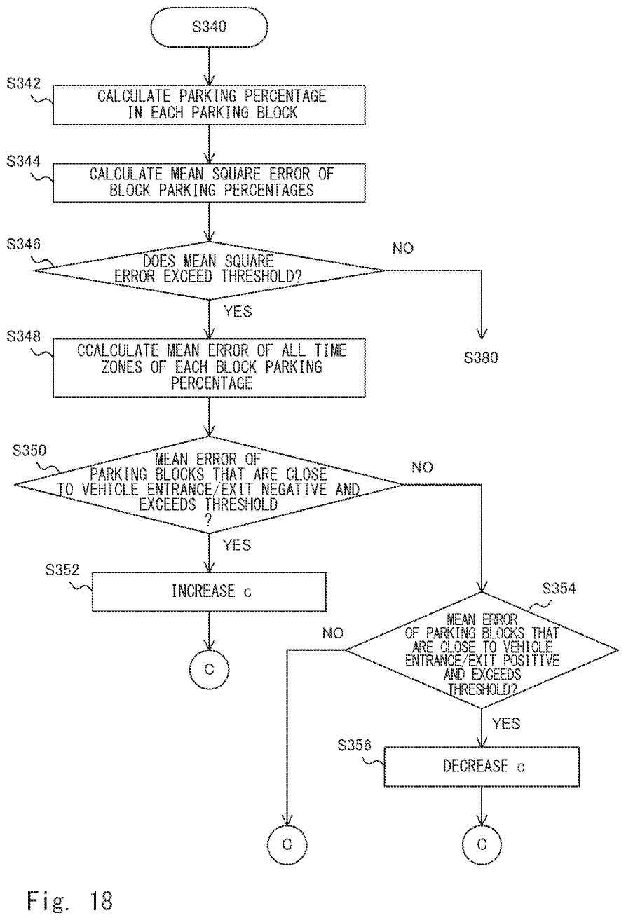

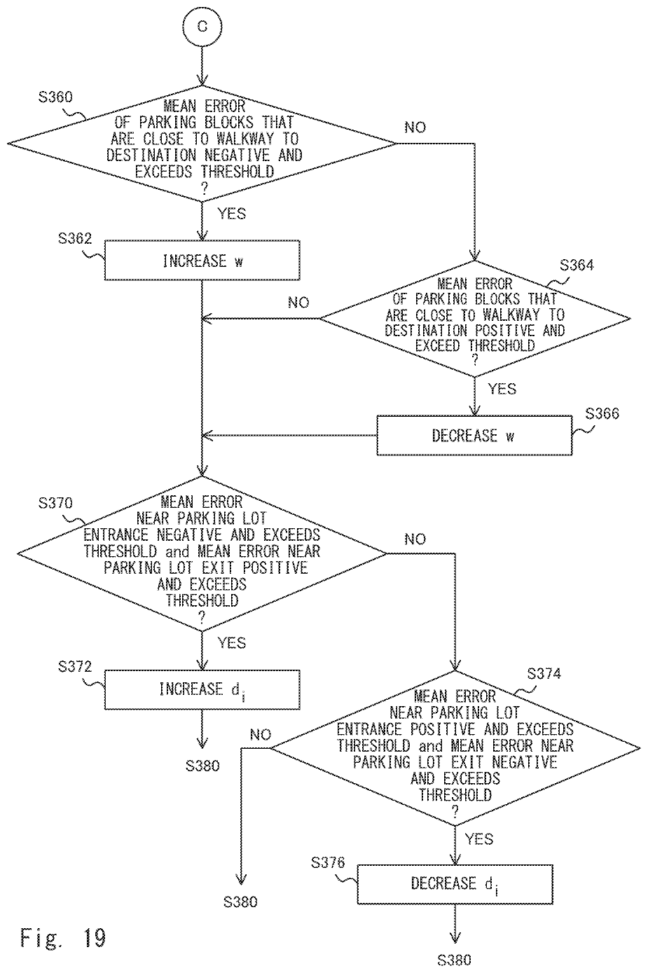

FIGS. 18 and 19 are flowcharts showing the processing of S340. The parking block utility function parameter adjustment unit 330 calculates, for the prediction result and measured result, the parking percentage (block parking percentage) of each of the parking blocks 60 in each time zone (Step S342). Note that the parking block utility function parameter adjustment unit 330 may calculate the block parking percentage for each of the parking blocks 60 in all the parking floors 80. Alternatively, the parking block utility function parameter adjustment unit 330 may calculate the block parking percentage for each of the parking blocks 60 in a specific parking floor 80 (for example, the entrance floor or a parking floor 80 in which the connection passage 76 is provided). Further, when, for example, the measured data is the one from 7:00 to 9:00, the parking block utility function parameter adjustment unit 330 may calculate, for the measured data, the parking percentage (measured parking percentage) of each of the parking blocks 60, for example, every 15 minutes. Likewise, the parking block utility function parameter adjustment unit 330 may calculate, for the prediction result, the parking percentage (predicted parking percentage) of each of the parking blocks 60 for example, every 15 minutes. In this case, the length of the time zone where the parking percentage is calculated is 15 minutes.

The parking block utility function parameter adjustment unit 330 calculates the mean square error of the calculated block parking percentages (Step S344). Specifically, the parking block utility function parameter adjustment unit 330 calculates the mean square error of the block parking percentages calculated for a prediction result and the block parking percentage calculated for the measured result. That is, the parking block utility function parameter adjustment unit 330 calculates the mean square error between the predicted parking percentage and the measured parking percentage calculated for each of the time zones and each of the parking blocks. When the block parking percentage has been calculated for all the parking floors 80, the parking block utility function parameter adjustment unit 330 may calculate the mean square error between the predicted parking percentage and the measured parking percentage calculated for each of the time zones and for each of the parking blocks of each of the parking floors. In this case, the number of pieces of data of the block parking percentage corresponds to the product of the number of time zones and the number of parking blocks 60 in all the parking floors 80.

The parking block utility function parameter adjustment unit 330 determines whether or not the mean square error exceeds a predetermined threshold (Step S346). When the mean square error does not exceed the threshold (NO in S346), the process flow proceeds to S380 (FIG. 16). On the other hand, when the mean square error exceeds the threshold (YES in S346), the parking block utility function parameter adjustment unit 330 calculates, for each of the parking blocks 60, the mean error of all the time zones (Step S348). Specifically, the parking block utility function parameter adjustment unit 330 calculates, for each of the parking blocks 60, the average value of the error of the parking percentage in each of the time zones (=predicted parking percentage−measured parking percentage). When the mean error of one parking block 60 is negative, the predicted parking percentage of the parking block 60 is smaller than the measured parking percentage. On the other hand, when the mean error of one parking block 60 is positive, the predicted parking percentage of the parking block 60 is larger than the measured parking percentage. Note that S348 and the following processing may be performed for the parking blocks 60 in one specific parking floor 80 (e.g., the entrance floor or the parking floor 80 where the connection passage 76 is provided).

Parking blocks 60 that are close to the vehicle entrance/exit 52 tend to be selected as the parking places where vehicles are parked since occupants can park their vehicles soon after they enter the parking lot and can exit from the parking lot soon after they get into their vehicles. Further, parking blocks 60 that are close to the walkway to the destination 54 tend to be selected as parking places where vehicles are parked since the occupants can easily access the destination G after they have their vehicles parked. Then, as the number of vehicles to be parked in these parking blocks 60 increases, there is a high probability that more vehicles will stack near these parking blocks 60. Therefore, in this example, in the adjustment of the parameters of the parking block utility function, parking blocks 60 that are close to the vehicle entrance/exit 52 and parking blocks 60 that are close to the walkway to the destination 54 are focused on.

The parking block utility function parameter adjustment unit 330 determines whether or not the mean error of the parking blocks 60 that are close to the vehicle entrance/exit 52 (in the example shown in FIG. 2, parking block numbers #13, #14 or the like) is negative and exceeds a threshold (Step S350). That is, the parking block utility function parameter adjustment unit 330 determines whether or not the mean error of the parking blocks 60 that are close to the vehicle entrance/exit 52 is negative and the absolute value of the mean error exceeds the threshold. When the mean error of the parking blocks 60 that are close to the vehicle entrance/exit 52 is negative and exceeds the threshold (YES in S350), it means that the predicted parking percentage of the parking blocks 60 that are close to the vehicle entrance/exit 52 is significantly smaller than the measured parking percentage. Therefore, the utility function parameters need to be adjusted in such a way that the predicted parking percentage of the parking blocks 60 that are close to the vehicle entrance/exit 52 may be predicted to be large. Therefore, in this case, the parking block utility function parameter adjustment unit 330 increases c in Expression (3) (Step S352). Accordingly, it is more likely that a prediction will be made in which a parking block 60 which makes the travelling time of the vehicle shorter is selected. Therefore, the predicted parking percentage for the parking blocks 60 that are close to the vehicle entrance/exit 52 may be predicted to be large. Then the process flow proceeds to S360.

On the other hand, when a condition that the mean error of the parking blocks 60 that are close to the vehicle entrance/exit 52 is negative and exceeds the threshold does not hold true (NO in S350), the parking block utility function parameter adjustment unit 330 determines whether or not the mean error of the parking blocks 60 that are close to the vehicle entrance/exit 52 is positive and exceeds the threshold (Step S354). That is, the parking block utility function parameter adjustment unit 330 determines whether or not the mean error of the parking blocks 60 that are close to the vehicle entrance/exit 52 is positive and the absolute value of the mean error exceeds the threshold. When the mean error of the parking blocks 60 that are close to the vehicle entrance/exit 52 is positive and exceeds the threshold (YES in S354), it means that the predicted parking percentage of the parking blocks 60 that are close to the vehicle entrance/exit 52 is significantly larger than the measured parking percentage. Therefore, the utility function parameters need to be adjusted in such a way that the predicted parking percentage of the parking blocks 60 that are close to the vehicle entrance/exit 52 is predicted to be small. That is, it means that c has been made too large in the previous adjustment. Therefore, the parking block utility function parameter adjustment unit 330 decreases c (Step S356). Then the process flow proceeds to S360. On the other hand, when a condition that the mean error of the parking blocks 60 that are close to the vehicle entrance/exit 52 is positive and exceeds the threshold does not hold true (NO in S354), the error of the predicted parking percentage of the parking blocks 60 that are close to the vehicle entrance/exit 52 may be within the allowable range. Then the process flow proceeds to S360.

The parking block utility function parameter adjustment unit 330 determines whether or not the mean error of the parking blocks 60 that are close to the walkway to the destination 54 (in the example shown in FIG. 2, parking block numbers #1 and #2 or the like) is negative and exceeds a threshold (Step S360). That is, the parking block utility function parameter adjustment unit 330 determines whether or not the mean error of the parking blocks 60 that are close to the walkway to the destination 54 is negative and the absolute value of the mean error exceeds the threshold. When the mean error of the parking blocks 60 that are close to the walkway to the destination 54 is negative and exceeds the threshold (YES in S360), it means that the predicted parking percentage of the parking blocks 60 that are close to the walkway to the destination 54 is significantly smaller than the measured parking percentage. Therefore, the utility function parameters need to be adjusted in such a way that the predicted parking percentage of the parking blocks 60 that are close to the walkway to the destination 54 is predicted to be large. Therefore, in this case, the parking block utility function parameter adjustment unit 330 increases w in Expression (3) (Step S362). Accordingly, it is more likely that a prediction will be made in which a parking block 60 that makes the walking time shorter is selected. Therefore, the predicted parking percentage for the parking blocks 60 that are close to the walkway to the destination 54 may be predicted to be large. Then the process flow proceeds to S370.

On the other hand, when a condition that the mean error of the parking blocks 60 that are close to the walkway to the destination 54 is negative and exceeds the threshold does not hold true (NO in S360), the parking block utility function parameter adjustment unit 330 determines whether or not the mean error of the parking blocks 60 that are close to the walkway to the destination 54 is positive and exceeds a threshold (Step S364). That is, the parking block utility function parameter adjustment unit 330 determines whether or not the mean error of the parking blocks 60 that are close to the walkway to the destination 54 is positive and the absolute value of the mean error exceeds the threshold. When the mean error of the parking blocks 60 that are close to the walkway to the destination 54 is positive and exceeds the threshold (YES in S364), it means that the predicted parking percentage of the parking blocks 60 that are close to the walkway to the destination 54 is significantly larger than the measured parking percentage. Therefore, the utility function parameters need to be adjusted in such a way that the predicted parking percentage of the parking blocks 60 that are close to the walkway to the destination 54 is predicted to be small. That is, it means that w has been made too large in the previous adjustment. Therefore, the parking block utility function parameter adjustment unit 330 decreases w (Step S366). Then the process flow proceeds to S370. On the other hand, when a condition that the mean error of the parking blocks 60 that are close to the walkway to the destination 54 is positive and exceeds the threshold does not hold true (NO in S364), the error of the predicted parking percentage of the parking blocks 60 that are close to the walkway to the destination 54 may be within an allowable range. Then the process flow proceeds to S370.

The parking block utility function parameter adjustment unit 330 determines whether or not the mean error of the parking blocks 60 that are close to the parking lot entrance (in the example shown in FIG. 2, the parking block number #14 or the like) is negative and exceeds a threshold, and whether or not the mean error of the parking blocks 60 that are close to the parking lot exit (in the example shown in FIG. 2, the parking block number #13 or the like) is positive and exceeds a threshold (Step S370). When the above determination is true (YES in S370), it means that the predicted parking percentage of the parking blocks 60 that are close to the parking lot entrance is much smaller than the measured parking percentage and the predicted parking percentage of the parking blocks 60 that are close to the parking lot exit is significantly larger than the measured parking percentage. Therefore, the utility function parameters need to be adjusted in such a way that the predicted parking percentage of the parking blocks 60 that are close to the parking lot entrance becomes large and the predicted parking percentage of the parking blocks 60 that are close to the parking lot exit becomes small. According to the current prediction, too many parking blocks 60 that are close to the parking lot exit tend to be selected and too many parking blocks 60 that are close to the parking lot entrance tend to not be selected. Therefore, in this case, the parking block utility function parameter adjustment unit 330 increases the weight dᵢ with respect to the travelling time at the time of entrance of “travelling time of the vehicle” in Expression (3) (Step S372). Accordingly, it is more likely that a prediction will be made in which a parking block 60 that makes the travelling time of the vehicle at the time of entrance shorter is selected. Therefore, the predicted parking percentage of the parking blocks 60 that are close to the parking lot entrance may be predicted to be large and the predicted parking percentage of the parking blocks 60 that are close to the parking lot exit may be predicted to be small. Then the process flow proceeds to S380.

On the other hand, when the aforementioned determination is false (NO in S370), the parking block utility function parameter adjustment unit 330 determines whether or not the mean error of the parking blocks 60 that are close to the parking lot entrance is positive and exceeds a threshold and whether the mean error of the parking blocks 60 that are close to the parking lot exit is negative and exceeds a threshold (Step S374). When the aforementioned determination is true (YES in S374), it means that the predicted parking percentage of the parking blocks 60 that are close to the parking lot entrance is significantly larger than the measured parking percentage and the predicted parking percentage of the parking blocks 60 that are close to the parking lot exit is significantly smaller than the measured parking percentage. Therefore, the utility function parameters need to be adjusted in such a way that the predicted parking percentage of the parking blocks 60 that are close to the parking lot entrance becomes small and the predicted parking percentage of the parking blocks 60 that are close to the parking lot exit becomes large. In the current prediction, too many parking blocks 60 that are close to the parking lot entrance tend to be selected and too many parking blocks 60 that are close to the parking lot exit tend to not be selected. Therefore, in this case, the parking block utility function parameter adjustment unit 330 decreases the weight dᵢ with respect to the travelling time at the time of entrance of the “travelling time of the vehicle” in Expression (3) (Step S376). Accordingly, it is more likely that a prediction will be made in which a parking block 60 that makes the travelling time of the vehicle at the time of exit shorter is selected. Therefore, the predicted parking percentage of the parking blocks 60 that are close to the parking lot exit may be predicted to be large and the predicted parking percentage of the parking blocks 60 that are close to the parking lot entrance may be predicted to be small. Then the process flow proceeds to S380.

It may also be possible that, in the processing of S340, the mean square error exceeds the threshold (YES in S346) but none of the utility function parameters c, w, and dᵢ is adjusted (NO in S350, NO in S354, NO in S360, NO in S364, NO in S370, and NO in S374). In this case, the parking block utility function parameter adjustment unit 330 may perform other adjustment processing. For example, the parking block utility function parameter adjustment unit 330 may adjust parameters other than c, w, and dᵢ. Alternatively, the parking block utility function parameter adjustment unit 330 may perform processing that is substantially similar to S348 to S376 for the parking floors 80 other than the parking floor 80 that has been processed in S348 and the following processing.

The determination unit 340 may determine whether or not the mean square error of the parking floors 80 and the mean square error of the parking blocks 60 both exceed the thresholds (S380). Then, the determination unit 340 may determine that the difference between the prediction result obtained by the prediction processing and the measured result is equal to or smaller than the threshold when the mean square error does not exceed the threshold for both the parking floors 80 and the parking blocks 60 (NO in S326 and NO in S346). In this case, the determination unit 340 may determine that the learning end condition is satisfied (YES in S380). Further, the determination unit 340 determines that the learning processing will be ended when the iteration number of times of the prediction processing reaches a predetermined upper limit.

If the difference between the prediction result and the measured result exceeds the threshold even after the iteration number of times of the prediction processing reaches the upper limit, parameters (e.g., β, p₁ and p₂) other than the parameter adjusted in the aforementioned processing may be adjusted. Further, if the difference between the prediction result and the measured result exceeds the threshold even after the iteration number of times of the prediction processing reaches the upper limit, the threshold may be set again and the aforementioned learning processing may be performed again. Further, if the difference between the prediction result and the measured result exceeds the threshold even after the iteration number of times of the prediction processing reaches the upper limit, the time zone in the measured data to be processed may be changed and then the aforementioned learning processing may be performed again. When, for example, the measured data is the one from 7:00 to 9:00, the learning processing may be performed using data from 7:00 to 8:00 (or 8:00 to 9:00) in the above time zone.

Alternatively, if the difference between the prediction result and the measured result exceeds the threshold even after the iteration number of times of the prediction processing reaches the upper limit, the aforementioned utility function may be changed in accordance with the structure of the target parking lot. When, for example, a specific parking floor such as a rooftop floor tends to be avoided, the expression of L in the aforementioned Expressions (2) and (3) may be changed as shown in the following Expression (10) or (11).

L=c·(travelling time of vehicle)+w·(walking time)×r (10)

L=(c·(travelling time of vehicle)+w·(walking time))×r (11)

The symbol r denotes a penalty parameter. When j corresponds to a parking block in a parking floor other than the rooftop floor, r=1. When j corresponds to a parking block in the rooftop floor, r>1. The symbol r may be adjusted by the learning processing.

The learning unit 300 of the parking lot management system 1 according to the second embodiment is configured to learn the utility function parameters in accordance with the operation conditions of the parking lot. With the configuration of the parking lot management system 1 according to the second embodiment, it becomes possible to adapt the utility function that matches the actual user's preference corresponding to the operation condition. Accordingly, the accuracy of the prediction (simulation) in the simulation unit 100 may be improved. Further, in the presenting processing in the presenting unit 200, it is possible to present parking places that are easily acceptable to actual users.

Note that, while the case in which utility function parameters are learned using measured data obtained in another parking lot of operation conditions that are close to the operation conditions of the parking lot to which utility function parameters are to be adapted has been described in the aforementioned learning method, this configuration is merely one example. Since measured data can be obtained in a parking lot after this parking lot starts to be operated, the utility function parameters may be relearned (updated) using this measured data. When, for example, the difference (error) between the obtained measured result and the prediction result exceeds a threshold, the utility function parameters may be automatically relearned. Further, when, for example, actual vehicles often do not move to the presented parking places in the processing of the presenting unit 200, it can be considered that the accuracy of the selection processing in the presenting unit 200 is low. In this case, the learning unit 300 may relearn the utility function parameters. Accordingly, it becomes possible to improve the accuracy of the selection processing and present parking places that are easily acceptable to actual vehicles (drivers or the like).

Further, there is a case in which it is possible to identify each vehicle (or driver or the like) by image recognition processing. In this case, when it is possible to sufficiently acquire results of recording of the actual parking place of each vehicle, the aforementioned learning processing may be performed for each vehicle using parameters adjusted without differentiating vehicles as initial values, and then parameters may be adjusted. Accordingly, it is possible to adapt the utility function parameters for each vehicle. Alternatively, the aforementioned learning processing may be performed for each of a group of vehicles grouped according to some criterion (e.g., the size of the vehicle or the type of the vehicle). The grouping may be performed, for example, according to the size of vehicle (a minicar, a small car, a large car, etc.) or the type of the vehicle (a sedan type or a minivan type).

### Modified Example

Note that the present disclosure is not limited to the aforementioned embodiments and may be changed as appropriate without departing from the spirit of the present disclosure. For example, the order of the steps in the aforementioned flowcharts may be changed as appropriate. Further, one or more steps in the aforementioned flowcharts may be omitted. Further, the aforementioned expressions are merely examples and other expressions may instead be employed.

Further, in the aforementioned embodiments, the simulation unit 100 generates an allocation list of vehicles that are planned to enter a parking lot in advance and controls, in a simulation, the movement of each of the vehicles in accordance with the allocation list. However, this configuration is merely one example. The simulation unit may allocate the parking blocks 60 to the vehicles in the simulation while performing the simulation for a virtual parking lot. In this case, the parking block selection unit may allocate the parking blocks 60 to the vehicles that are going to enter the parking lot in the simulation. The same holds true for the allocation of the parking floors 80.

Further, the parking lot managed by the parking lot management system 1 may be an underground parking lot. In this case, the uppermost floor of the parking lot may be an entrance floor. Further, a multistory parking lot managed by the parking lot management system 1 may have a configuration in which a vehicle enters from a parking floor other than the underground or ground floor or the top floor and moves to another upper or lower floor of the parking floor that is different from the floor where the entrance is provided. In this case, the parking floor that this vehicle enters is an entrance floor.

Further, the multistory parking lot managed by the parking lot management system 1 may be a continuous tilt floor parking lot. In the continuous tilt floor parking lot, parking spaces are provided along a slope and parking places are not divided for each floor. Therefore, in this case, the aforementioned utility function V_{O}(O_{f}) may not be used.

In the adjustment of the parking floor utility function parameters (S320) in the continuous tilt floor parking lot, it may be determined, in the processing of S330, whether the mean error of the entrance floor is negative and exceeds a threshold. When the mean error of the entrance floor is negative and exceeds the threshold (YES in S330), the utility function parameters need to be adjusted in such a way that the predicted parking percentage of the entrance floor is predicted to be large. Therefore, in this case, the parking floor utility function parameter adjustment unit 320 may increase β in Expression (6) (S332).

On the other hand, when a condition that the mean error of the entrance floor is negative and exceeds the threshold does not hold true (NO in S330), the parking floor utility function parameter adjustment unit 320 may determine whether the mean error of the entrance floor is positive and exceeds a threshold (S334). When the mean error of the entrance floor is positive and exceeds the threshold (YES in S334), the utility function parameters need to be adjusted in such a way that the predicted parking percentage of the entrance floor is predicted to be small. That is, it means that β has been made too large in the previous adjustment. Therefore, the parking floor utility function parameter adjustment unit 320 may decrease β (S336).

The aforementioned program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A parking lot management system for managing a parking lot including a plurality of parking spaces so as to enable one vehicle to be parked, the parking lot management system comprising:
a parking lot condition acquisition unit configured to acquire a parking lot condition, which is a condition of a parking block formed of the plurality of parking spaces that are adjacent to each other;
a parking block utility calculation unit configured to calculate a utility of each of a plurality of parking blocks using a parking block utility function, which is a utility function set in advance regarding the parking block, based on the parking lot condition; and
a parking block selection unit configured to select parking blocks to be allocated to a plurality of respective vehicles based on the utility of each of the plurality of parking blocks.

2. The parking lot management system according to claim 1, wherein the parking block selection unit selects parking blocks to be allocated to the respective vehicles in accordance with timings when the plurality of respective vehicles enter the parking lot or before the respective vehicles enter the parking lot.

3. The parking lot management system according to claim 1, wherein a parameter included in the parking block utility function is adapted in accordance with an operation condition of the parking lot.

4. The parking lot management system according to claim 3, wherein the parameter included in the parking block utility function is adapted in accordance with at least one of a type of the parking lot, a time zone, a season, and a weather.

5. The parking lot management system according to claim 1, wherein the parking block utility calculation unit calculates the utility in accordance with a number of parking spaces in the parking block where vehicles are not parked.

6. The parking lot management system according to claim 5, wherein the parking block utility calculation unit calculates the utility using a utility function whose value decreases as the number of parking spaces in the parking block where vehicles are not parked decreases.

7. The parking lot management system according to claim 1, wherein
the parking lot management system manages a parking lot including a plurality of parking floors, each of the parking floors including a plurality of the parking blocks,
the parking lot management system further comprises a parking floor utility calculation unit configured to calculate the utility of each of the plurality of parking floors using a parking floor utility function, which is a utility function set in advance regarding the parking floor,
the parking lot management system further comprises a parking floor selection unit configured to select parking floors to be allocated to the plurality of respective vehicles based on the utility of each of the parking floors,
the parking block utility calculation unit calculates the utility of the parking block in the selected parking floor, and
the parking block selection unit selects the parking block in the selected parking floor.

8. The parking lot management system according to claim 1, wherein
the parking lot management system manages a virtual parking lot, and
the parking lot management system further comprises a simulation processing unit configured to perform processing so as to operate the vehicle by a simulation, the selected parking block being a moving destination.

9. The parking lot management system according to claim 1, wherein
the parking lot management system manages an actual parking lot, and
the parking lot management system further comprises a presenting processing unit configured to perform processing for presenting information where the selected parking block is set as a moving destination for the vehicle which enters the parking lot.

10. The parking lot management system according to claim 1, further comprising a learning unit configured to learn a parameter of the utility function in accordance with an operation condition of the parking lot.

11. A parking lot management method for managing a parking lot including a plurality of parking spaces so as to enable one vehicle to be parked, the parking lot management method comprising:
acquiring a parking lot condition, which is a condition of a parking block formed of the plurality of parking spaces that are adjacent to each other;
calculating a utility of each of a plurality of parking blocks using a parking block utility function, which is a utility function set in advance regarding the parking block, based on the parking lot condition, and
selecting parking blocks to be allocated to a plurality of respective vehicles based on the utility of each of the plurality of parking blocks.

12. A non-transitory computer readable medium storing a program executing a parking lot management method for managing a parking lot including a plurality of parking spaces so as to enable one vehicle to be parked, the program causing a computer to execute the processing of:
acquiring a parking lot condition, which is a condition of a parking block formed of the plurality of parking spaces that are adjacent to each other;
calculating a utility of each of a plurality of parking blocks using a parking block utility function, which is a utility function set in advance regarding the parking block, based on the parking lot condition, and
selecting parking blocks to be allocated to a plurality of respective vehicles based on the utility of each of the plurality of parking blocks.
